(19) United States
(12) Patent Application Publication
(10) Pub. No.: US 2023/0231651 A1
(43) Pub. Date: Jul. 20, 2023

(54) SEMI-PERSISTENT CHANNEL STATE INFORMATION REFERENCE SIGNAL HANDLING FOR MULTICAST

(71) Applicant: QUALCOMM Incorporated, San Diego, CA (US)

(72) Inventors: Kazuki Takeda, Minato-ku (JP); Le Liu, San Jose, CA (US); Peter Gaal, San Diego, CA (US); Alberto Rico Alvarino, San Diego, CA (US)

(21) Appl. No.: 17/955,433

(22) Filed: Sep. 28, 2022

Related U.S. Application Data
(60) Provisional application No. 63/300,238, filed on Jan. 17, 2022.

(51) Int. Cl. H04L 1/00; H04B 7/06

(52) U.S. Cl. CPC H04L 1/0067; H04L 1/0061; H04B 7/0626

(57) ABSTRACT

Methods, systems, and devices for wireless communications are described. The method may include a user equipment (UE) receiving, from a base station, signaling configuring the UE with a semi-persistent (SP) channel state information reference signal (CSI-RS) resource set. Additionally, the UE may receive, from the base station, signaling configuring the UE to communicate using multicast signaling via a multicast downlink shared channel. The UE may receive an activation command activating the SP CSI-RS resource set. The UE may apply a rule and based on the activation command and the rule perform rate matching on the multicast downlink shared channel around either multicast or unicast resources of the CSI-RS resource set.

### CROSS REFERENCE

The present application for patent claims the benefit of U.S. Provisional Patent Application No. 63/300,238 by TAKEDA et al., entitled “SEMI-PERSISTENT CHANNEL STATE INFORMATION REFERENCE SIGNAL HANDLING FOR MULTICAST,” filed Jan. 17, 2022, assigned to the assignee hereof, and expressly incorporated by reference herein.

### FIELD OF TECHNOLOGY

The following relates to wireless communications, including semi-persistent (SP) channel state information reference signal (CSI-RS) handling for multicast.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support semi-persistent (SP) channel state information reference signal (CSI-RS) handling for multicast. Generally, the described techniques provide for a user equipment (UE) to receive an activation command activating a SP CSI-RS resource set for multicast communication. In some examples, the UE may receive, from a base station (or a network device), signaling that configures the UE with one or more SP CSI-RS resource sets for SP CSI-RSs. An SP CSI-RS may a non-zero power (NZP)-CSI-RS or a zero power (ZP)-CSI-RS. Additionally, the UE may receive, from the base station, signaling configuring the UE for multicast signaling. Multicast signaling may occur over resources of a common frequency resource (CFR). The CFR may include resources of a first bandwidth part (BWP) allocated to the UE as well as resources of a second BWP allocated to one or more different UEs. The UE may then receive an activation command activating a SP CSI-RS resource set of the one or more configured SP CSI-RS resource sets. In some examples, the UE may receive the activation command via a medium access control control element (MAC CE) carried in a multicast physical downlink shared channel (PDSCH) or a unicast PDSCH. Upon receiving the activation command, the UE may receive, from the base station, multicast signaling by rate-matching around the activated CSI-RS resource set.

A method for wireless communications at a first user equipment (UE) is described. The method may include receiving, from a network device, a first message indicating a first configuration for a CSI-RS resource set to be activated by an activation command, where the CSI-RS resource set is for a CSI-RS, the CSI-RS including a NZP-CSI-RS or a ZP-CSI-RS, receiving, from the network device, a second message indicating a second configuration for use by the first UE for multicast signaling via a multicast downlink shared channel over a first set of resources that are included in a first bandwidth part (BWP) allocated to the first UE for receiving the multicast signaling, receiving, from the network device, the activation command activating the CSI-RS resource set, and receiving the multicast signaling from the network device by rate-matching, based on the activation command, around a subset of the first set of resources, where the subset is allocated for the CSI-RS.

An apparatus for wireless communications is described. The apparatus may include a processor, memory coupled with the processor, and instructions stored in the memory. The instructions may be executable by the processor to cause the apparatus to receive, from a network device, a first message indicating a first configuration for a CSI-RS resource set to be activated by an activation command, where the CSI-RS resource set is for a CSI-RS, the CSI-RS including a NZP-CSI-RS or a ZP-CSI-RS, receive, from the network device, a second message indicating a second configuration for use by the first UE for multicast signaling via a multicast downlink shared channel over a first set of resources that are included in a first BWP allocated to the first UE for receiving the multicast signaling, receive, from the network device, the activation command activating the CSI-RS resource set, and receive the multicast signaling from the network device by rate-matching, based on the activation command, around a subset of the first set of resources, where the subset is allocated for the CSI-RS.

Another apparatus for wireless communications is described. The apparatus may include means for receiving, from a network device, a first message indicating a first configuration for a CSI-RS resource set to be activated by an activation command, where the CSI-RS resource set is for a CSI-RS, the CSI-RS including a NZP-CSI-RS or a ZP-CSI-RS, means for receiving, from the network device, a second message indicating a second configuration for use by the first UE for multicast signaling via a multicast downlink shared channel over a first set of resources that are included in a first BWP allocated to the first UE for receiving the multicast signaling, means for receiving, from the network device, the activation command activating the CSI-RS resource set, and means for receiving the multicast signaling from the network device by rate-matching, based on the activation command, around a subset of the first set of resources, where the subset is allocated for the CSI-RS.

A non-transitory computer-readable medium storing code for wireless communications at a first UE is described. The code may include instructions executable by a processor to receive, from a network device, a first message indicating a first configuration for a CSI-RS resource set to be activated by an activation command, where the CSI-RS resource set is for a CSI-RS, the CSI-RS including a NZP-CSI-RS or a ZP-CSI-RS, receive, from the network device, a second message indicating a second configuration for use by the first UE for multicast signaling via a multicast downlink shared channel over a first set of resources that are included in a first BWP allocated to the first UE for receiving the multicast signaling, receive, from the network device, the activation command activating the CSI-RS resource set, and receive the multicast signaling from the network device by rate-matching, based on the activation command, around a subset of the first set of resources, where the subset is allocated for the CSI-RS.

In some examples of the method, apparatuses, and non-transitory computer-readable medium described herein, receiving the activation command may include operations, features, means, or instructions for receiving a MAC CE carried by the multicast downlink shared channel, the MAC CE including the activation command.

Some examples of the method, apparatuses, and non-transitory computer-readable medium described herein may further include operations, features, means, or instructions for identifying the subset of the first set of resources as a multicast resource set for the CSI-RS based on a resource set index (ID) included within the activation command and the MAC CE being carried by the multicast downlink shared channel.

Some examples of the method, apparatuses, and non-transitory computer-readable medium described herein may further include operations, features, means, or instructions for refraining from rate-matching around a unicast resource set for the CSI-RS based on the MAC CE being carried by the multicast downlink shared channel.

In some examples of the method, apparatuses, and non-transitory computer-readable medium described herein, the multicast downlink shared channel may be for multicast communications based on the multicast downlink shared channel being scheduled by a downlink control information (DCI) format having a cyclic redundancy check (CRC) scrambled by a group random network temporary identifier (G-RNTI) or by a group configured scheduling RNTI (G-CS-RNTI), the multicast downlink shared channel being activated by a DCI format having a CRC scrambled by a G-CS-RNTI, or the multicast downlink shared channel being configured by a downlink shared channel multicast configuration or a common frequency resource configuration.

In some examples of the method, apparatuses, and non-transitory computer-readable medium described herein, receiving the activation command may include operations, features, means, or instructions for receiving a MAC CE carried by a unicast downlink shared channel, the MAC CE including the activation command.

Some examples of the method, apparatuses, and non-transitory computer-readable medium described herein may further include operations, features, means, or instructions for identifying the subset of the first set of resources as a multicast resource set for the CSI-RS based on a resource set ID included within the activation command, the resource set ID.

Some examples of the method, apparatuses, and non-transitory computer-readable medium described herein may further include operations, features, means, or instructions for receiving a second activation command activating a second CSI-RS resource set, the second activation command received via a second MAC CE by the unicast downlink shared channel, identifying a subset of a second set of resources as a unicast resource set for a second CSI-RS based on a resource set ID included within the second activation command, and receiving unicast signaling from the network device by rate-matching, based on the second activation command, around the subset of the second set of resources, where the subset is allocated for the second CSI-RS.

Some examples of the method, apparatuses, and non-transitory computer-readable medium described herein may further include operations, features, means, or instructions for identifying the subset of the first set of resources as a multicast resource set for the CSI-RS and a second subset of a second set of resources as a unicast resource set for the CSI-RS, the identifying of both the subset and the second subset based on a resource set ID included within the activation command, the resource set ID mapped to both the multicast resource set and the unicast resource set.

Some examples of the method, apparatuses, and non-transitory computer-readable medium described herein may further include operations, features, means, or instructions for identifying the subset of the first set of resources as a multicast resource set for the CSI-RS based on a BWP ID included within the activation command, the BWP ID being associated with the first set of resources.

In some examples of the method, apparatuses, and non-transitory computer-readable medium described herein, identifying the subset of the first set of resources may include operations, features, means, or instructions for identifying the subset of the first set of resources based on a resource set ID included within the activation command.

In some examples of the method, apparatuses, and non-transitory computer-readable medium described herein, the unicast downlink shared channel may be for unicast communications based on the unicast downlink shared channel being scheduled by a DCI format having an CRC scrambled by a cell RNTI (C-RNTI), by a modulation and coding scheme cell RNTI (MCS-C-RNTI), or by a configured scheduling RNTI (CS-RNTI), the unicast downlink shared channel being activated by a DCI format having a CRC scrambled by a CS-RNTI, or the unicast downlink shared channel being configured by a downlink shared channel configuration, a downlink BWP configuration, or a serving cell configuration.

Some examples of the method, apparatuses, and non-transitory computer-readable medium described herein may further include operations, features, means, or instructions for determining an activation delay for application of the activation command, the activation delay being a threshold duration after a hybrid automatic repeat request (HARQ) feedback opportunity responsive to a downlink shared channel carrying the activation command.

Some examples of the method, apparatuses, and non-transitory computer-readable medium described herein may further include operations, features, means, or instructions for determining an activation delay for application of the activation command, the activation delay being a threshold duration after a minimum possible timing for a HARQ feedback opportunity responsive to a downlink shared channel carrying the activation command.

Some examples of the method, apparatuses, and non-transitory computer-readable medium described herein may further include operations, features, means, or instructions for determining an activation delay for application of the activation command, the activation delay being a threshold duration after a downlink shared channel carrying the activation command.

A method for wireless communications at a network device is described. The method may include transmitting a first message indicating a first configuration for a CSI-RS resource set to be activated by an activation command, where the CSI-RS resource set is for a CSI-RS, the CSI-RS including a NZP-CSI-RS or a ZP-CSI-RS, transmitting a second message indicating a second configuration for use by the first UE for multicast signaling via a multicast downlink shared channel over a first set of resources that are included in a first BWP allocated to the first UE for the multicast signaling and in a second BWP allocated to one or more second UEs for the multicast signaling, transmitting the activation command activating the CSI-RS resource set, and transmitting the multicast signaling by rate-matching, based on the activation command, around a subset of the first set of resources, where the subset is allocated for the CSI-RS.

An apparatus for wireless communications is described. The apparatus may include a processor, memory coupled with the processor, and instructions stored in the memory. The instructions may be executable by the processor to cause the apparatus to transmit, to a first UE, a first message indicating a first configuration for a CSI-RS resource set to be activated by an activation command, where the CSI-RS resource set is for a CSI-RS, the CSI-RS including a NZP-CSI-RS or a ZP-CSI-RS, transmit, to the first UE, a second message indicating a second configuration for use by the first UE for multicast signaling via a multicast downlink shared channel over a first set of resources that are included in a first BWP allocated to the first UE for the multicast signaling and in a second BWP allocated to one or more second UEs for the multicast signaling, transmit, to the first UE, the activation command activating the CSI-RS resource set, and transmit the multicast signaling to the first UE by rate-matching, based on the activation command, around a subset of the first set of resources, where the subset is allocated for the CSI-RS.

Another apparatus for wireless communications is described. The apparatus may include means for transmitting, to a first UE, a first message indicating a first configuration for a CSI-RS resource set to be activated by an activation command, where the CSI-RS resource set is for a CSI-RS, the CSI-RS including a NZP-CSI-RS or a ZP-CSI-RS, means for transmitting, to the first UE, a second message indicating a second configuration for use by the first UE for multicast signaling via a multicast downlink shared channel over a first set of resources that are included in a first BWP allocated to the first UE for the multicast signaling and in a second BWP allocated to one or more second UEs for the multicast signaling, means for transmitting, to the first UE, the activation command activating the CSI-RS resource set, and means for transmitting the multicast signaling to the first UE by rate-matching, based on the activation command, around a subset of the first set of resources, where the subset is allocated for the CSI-RS.

A non-transitory computer-readable medium storing code for wireless communications at a network device is described. The code may include instructions executable by a processor to transmit, to a first UE, a first message indicating a first configuration for a CSI-RS resource set to be activated by an activation command, where the CSI-RS resource set is for a CSI-RS, the CSI-RS including a NZP-CSI-RS or a ZP-CSI-RS, transmit, to the first UE, a second message indicating a second configuration for use by the first UE for multicast signaling via a multicast downlink shared channel over a first set of resources that are included in a first BWP allocated to the first UE for the multicast signaling and in a second BWP allocated to one or more second UEs for the multicast signaling, transmit, to the first UE, the activation command activating the CSI-RS resource set, and transmit the multicast signaling to the first UE by rate-matching, based on the activation command, around a subset of the first set of resources, where the subset is allocated for the CSI-RS.

In some examples of the method, apparatuses, and non-transitory computer-readable medium described herein, transmitting the activation command may include operations, features, means, or instructions for transmitting a MAC CE carried by the multicast downlink shared channel, the MAC CE including the activation command.

In some examples of the method, apparatuses, and non-transitory computer-readable medium described herein, the activation command includes a resource set ID assigned to the subset of the first set of resources.

In some examples of the method, apparatuses, and non-transitory computer-readable medium described herein, the multicast downlink shared channel may be for multicast communications based on the multicast downlink shared channel being scheduled by a DCI format having an CRC scrambled by a G-RNTI or by a G-CS-RNTI, the multicast downlink shared channel being activated by a DCI format having a CRC scrambled by a G-CS-RNTI, or the multicast downlink shared channel being configured by a downlink shared channel multicast configuration or a common frequency resource configuration.

In some examples of the method, apparatuses, and non-transitory computer-readable medium described herein, transmitting the activation command may include operations, features, means, or instructions for transmitting a MAC CE carried by a unicast downlink shared channel, the MAC CE including the activation command.

In some examples of the method, apparatuses, and non-transitory computer-readable medium described herein, the activation command includes a resource set ID that may be mapped to the multicast resource set.

In some examples of the method, apparatuses, and non-transitory computer-readable medium described herein, the activation command includes a resource set ID that may be mapped to both the multicast resource set and a unicast resource set.

In some examples of the method, apparatuses, and non-transitory computer-readable medium described herein, the activation command includes a BWP ID associated with the first set of resources.

In some examples of the method, apparatuses, and non-transitory computer-readable medium described herein, the unicast downlink shared channel may be for unicast communications based on the unicast downlink shared channel being scheduled by a DCI format having an CRC scrambled by a C-RNTI, by a MCS-C-RNTI, or by a CS-RNTI, the unicast downlink shared channel being activated by a DCI format having a CRC scrambled by a CS-RNTI, or the unicast downlink shared channel being configured by a downlink shared channel configuration, a downlink BWP configuration, or a serving cell configuration.

Some examples of the method, apparatuses, and non-transitory computer-readable medium described herein may further include operations, features, means, or instructions for determining an activation delay for application of the activation command, the activation delay being a threshold duration after a HARQ feedback opportunity responsive to a downlink shared channel carrying the activation command.

Some examples of the method, apparatuses, and non-transitory computer-readable medium described herein may further include operations, features, means, or instructions for determining an activation delay for application of the activation command, the activation delay being a threshold duration after a minimum possible timing for a HARQ feedback opportunity responsive to a downlink shared channel carrying the activation command.

Some examples of the method, apparatuses, and non-transitory computer-readable medium described herein may further include operations, features, means, or instructions for determining an activation delay for application of the activation command, the activation delay being a threshold duration after a downlink shared channel carrying the activation command.

### BRIEF DESCRIPTION OF THE DRAWINGS

FIGS. 1 and 2 illustrate examples of a wireless communications system that supports semi-persistent channel state information reference signal (SP CSI-RS) handling for multicast in accordance with aspects of the present disclosure.

FIGS. 3A, 3B, and 3C illustrate examples of an activation timing diagram that supports SP CSI-RS handling for multicast in accordance with aspects of the present disclosure.

FIGS. 4A and 4B illustrate examples of an activation scheme that supports SP CSI-RS handling for multicast in accordance with aspects of the present disclosure.

FIG. 5 illustrates an example of a process flow that supports SP CSI-RS handling for multicast in accordance with aspects of the present disclosure.

FIGS. 6 and 7 show block diagrams of devices that support SP CSI-RS handling for multicast in accordance with aspects of the present disclosure.

FIG. 8 shows a block diagram of a communications manager that supports SP CSI-RS handling for multicast in accordance with aspects of the present disclosure.

FIG. 9 shows a diagram of a system including a device that supports SP CSI-RS handling for multicast in accordance with aspects of the present disclosure.

FIGS. 10 and 11 show block diagrams of devices that support SP CSI-RS handling for multicast in accordance with aspects of the present disclosure.

FIG. 12 shows a block diagram of a communications manager that supports SP CSI-RS handling for multicast in accordance with aspects of the present disclosure.

FIG. 13 shows a diagram of a system including a device that supports SP CSI-RS handling for multicast in accordance with aspects of the present disclosure.

FIGS. 14 through 17 show flowcharts illustrating methods that support SP CSI-RS handling for multicast in accordance with aspects of the present disclosure.

### DETAILED DESCRIPTION

In some examples, a user equipment (UE) may be configured to receive a channel state information reference signal (CSI-RS). The CSI-RS may be a non-zero power (NZP)-CSI-RS or zero power (ZP)-CSI-RS. In the case of a NZP-CSI-RS, the UE may measure the received reference signal to determine channel measurements and tracking. A UE that is not receiving a NZP-CSI-RS may instead be configured for a ZP-CSI-RS, which may inform the UE of the resources being used to transmit NZP-CSI-RSs to other UEs, thus allowing the UE receiving the ZP-CSI-RS to avoid interference that might arise from NZP-CSI-RSs (by rate-matching around the resources reserved for the ZP-CSI-RS). CSI-RSs may also be configured semi-persistently as semi-persistent (SP) CSI-RSs. These SP-CSI-RSs are activated when a UE receives an activation message via a physical downlink shared channel (PDSCH). The activation message may inform the UE of a resource set on which the SP CSI-RSs (ZP-CSI-RS or NZP-CSI-RS) are to be activated.

In addition, the UE may be configured to receive multicast signaling. Unlike unicast signaling, multicast signaling may be intended for multiple UEs. As such, the resources allocated for multicast signaling may be included in bandwidth parts (BWPs) of different UEs (e.g., a common frequency resource (CFR)). The details of activation of SP-CSI RS resources in a multicast scenario are described herein.

A UE that is configured for SP CSI-RSs and multicast communications will rely on one or more rules to allow the UE to know which resource sets are activated for an SP CSI-RS. For example, the UE may be configured with one or more sets of SP CSI-RSs which could occur in different resource sets, where each resource set is assigned a resource set index (ID). In accordance with one rule, the UE may determine which resource set is to be activated based on a combination of a resource set ID included in the activation message and the type of communication used for the activation message. In one example, if the activation message is carried in multicast PDSCH, then the resource set activated is a multicast resource set, as identified by the resource set ID in the activation message. In another example, if the activation message is carried in a unicast PDSCH, then the resource set activated is a unicast resource set, as identified by the resource set ID in the activation message.

In another example, the individual resource set IDs may each be unique, even across multicast and unicast resource sets. In such example, the UE may determine whether the activated resource set is multicast or unicast based on the resource set ID. If a resource set ID is assigned to both multicast and unicast resource sets, both are activated. In a final example, the resource set IDs may be common, but the activation message may also include a BWP ID that specifies either a multicast-associated BWP or a unicast-associated BWP. In such example, the UE may determine whether the activated resource set is multicast or unicast based on a combination of the resource set ID and the corresponding BWP included in the activation message. For all of the examples, an activation delay is also specified, allowing both the UE and base station to understand when, after transmission of the activation message, the SP-CSI-RS resource sets will be activated. The methods as described herein enable CSI-RS handling for multicast.

Aspects of the disclosure are initially described in the context of wireless communications systems. Additional aspects are described in the context of activation timing diagrams, activation schemes, and a process flow. Aspects of the disclosure are further illustrated by and described with reference to apparatus diagrams, system diagrams, and flowcharts that relate to semi-persistent CSI-RS handling for multicast.

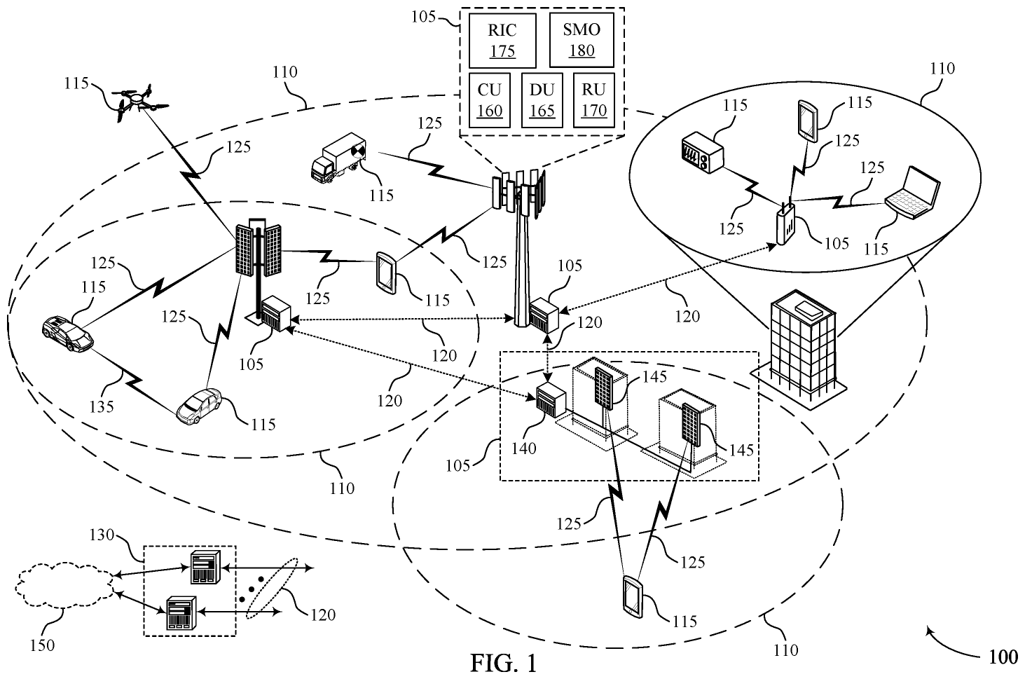

FIG. 1 illustrates an example of a wireless communications system 100 that supports semi-persistent CSI-RS handling for multicast in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

In some examples, a base station 105 may be implemented in a disaggregated architecture (e.g., a disaggregated base station architecture, a disaggregated RAN architecture), which may be configured to utilize a protocol stack that is physically or logically distributed among two or more base stations 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, the base station 105 may include one or more of a central unit (CU) 160, a distributed unit (DU) 165, a radio unit (RU) 170, a RAN Intelligent Controller (MC) 175 (e.g., a Near-Real Time MC (Near-RT RIC), a Non-Real Time MC (Non-RT MC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the base stations 105 in a disaggregated RAN architecture may be co-located, or one or more components of the base stations 105 may be located in distributed locations (e.g., separate physical locations). In some examples, one or more base stations 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network base stations 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more base stations 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor base station 105. The one or more donor base stations 105 (e.g., IAB donors) may be in communication with one or more additional base stations 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support physical layer association of extended reality data as described herein. For example, some operations described as being performed by a UE 115 or a base station 105 may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a BWP) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) N4 seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, for example in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

As described herein, the UE 115 may receive an activation command activating a SP CSI-RS resource set for multicast communication. In some examples, the UE 115 may receive, from the base station 105, signaling that configures the UE 115 with one or more SP CSI-RS resource sets for SP CSI-RSs. An SP CSI-RS may be a NZP-CSI-RS or a ZP-CSI-RS. Additionally, the UE 115 may receive, from the base station 105, signaling configuring the UE 115 for multicast signaling. Multicast signaling may occur over resources of a CFR. The CFR may include resources of a first BWP allocated to the UE 115 as well as resources of a second BWP allocated to a different UE 115. The UE 115 may then receive an activation command activating a SP CSI-RS resource set of the one or more configured SP CSI-RS resource sets. In some examples, the UE 115 may receive the activation command via a medium access control control element (MAC CE) carried in a multicast PDSCH or a unicast PDSCH. Upon receiving the activation command, the UE 115 may receive, from the base station 105, multicast signaling by rate-matching around the activated CSI-RS resource set.

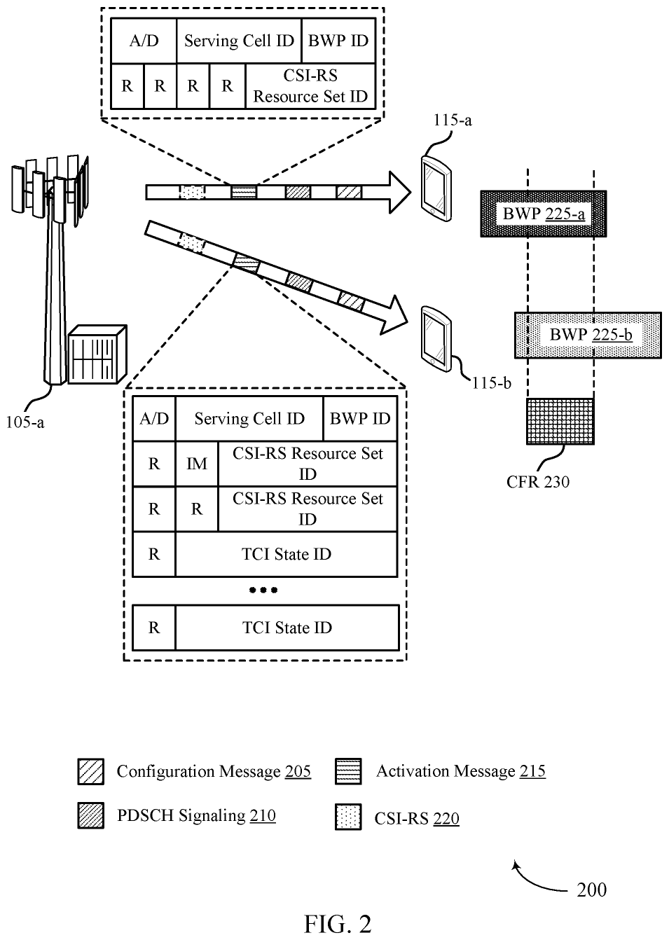

FIG. 2 illustrates an example of a wireless communications system 200 that supports semi-persistent CSI-RS handling for multicast in accordance with aspects of the present disclosure. The wireless communications system 200 may include a base station 105-a, a UE 115-a, and a UE 115-b. In some examples, the wireless communications system 200 may implement aspects of a wireless communications system 100. For example, the base station 105-a may be an example of a base station 105 as described in FIG. 1. Additionally, the UE 115-a and the UE 115-b may be examples of a UE 115 as described in FIG. 1.

In some examples, the wireless communications system 200 may support unicast communication and multicast communication. Unicast communication may refer to communication between a single transmitter (e.g., the base station 105-a) and a single receiver (e.g., the UE 115-a or the UE 115-b). Multicast communication, on the other hand, may refer to communication between a single transmitter (e.g., the base station 105-a) and one or more receivers (e.g., the UE 115-a and the UE 115-b). In some examples, each UE 115 may be scheduled to communicate with the base station 105-a using resources of a BWP 225. As shown in FIG. 2, the UE 115-a may communicate with the base station 105-a using resources of a BWP 225-a and the UE 115-b may communicate with the base station 105-a using resources of a BWP 225-b. In some examples, the BWP 225-a may include resources that do not overlap resources of the BWP 225-b.

For unicast communication, the base station 105-a may transmit signaling to the UE 115-a using resources of the BWP 225-a. In unicast communication, the base station 105-a may transmit downlink control information (DCI) whose CRC is scrambled by an radio network temporary identifier (RNTI) that is recognizable to the UE 115-a, but may not be recognizable to the UE 115-b (e.g., a cell RNTI (C-RNTI)). The DCI may schedule the UE 115-a to receive data transmissions which are scrambled by the same RNTI (e.g., unicast PDSCH transmissions). For multicast communication, the base station 105-a may transmit signaling to the UE 115-a and the UE 115-b using resources of a CFR 230. In multicast communication, the base station 105-a may transmit DCI whose CRC is scrambled using an RNTI that is recognizable to multiple UEs 115 (e.g., group RNTI (G-RNTI) or group configured scheduling RNTI (G-CS-RNTI)). The DCI may schedule the UE 115-a to receive data transmissions that are scrambled by the same RNTI (e.g., multicast PDSCH transmissions). The CFR 230 may include at least a portion of the resources that make up the BWP 225-a and at least a portion of the resources that make up the BWP 225-b. In some examples, the UE 115 may receive signaling from the base station 105-a configuring the UE 115 with the CFR 230. The configuration message may indicate a starting physical resource block (PRB), a quantity of PRBs, a PDSCH configuration, a physical downlink control channel (PDCCH) configuration, a SPS configuration. In some examples, there may be no more than one CFR 230 per BWP 225.

In some examples, the UE 115 may utilize a SP CSI-RS 220. The SP CSI-RS 220 may be configured to be a NZP-CSI-RS or a ZP-CSI-RS. The UE 115 may utilize the NZP-CSI-RS for purposes such as channel measurement or tracking. The ZP-CSI-RS, on the other hand, may correspond to empty resources and as such, the UE 115 may utilize the ZP-CSI-RS to measure interference (e.g., interference caused by NZP-CSI-RS transmitted to other UEs 115). For SP CSI-RS, the UE 115 may receive a configuration message 205 from the base station 105-a, where the configuration message 205 includes information related to the SP CSI-RS 220. As one example, the configuration message 205 may include an indication of one or more CSI-RS resource sets allocated for the SP CSI-RS 220 (e.g., CSI-RS resource sets) and a periodicity of the SP CSI-RS 220. In some examples, the SP CSI-RS 220 may be configured for each BWP 225. As such, the UE 115-a may receive a configuration message 205 configuring the UE 115-a with the SP CSI-RS 220 to use for communication on the BWP 225-a and the UE 115-b may receive a configuration message 205 configuring the UE 115-b with the SP CSI-RS to use for communication on the BWP 225-a. The configuration message 205 may be provided to the UEs 115 via radio resource control (RRC) signaling.

In some examples, the SP CSI-RS 220 may be activated or deactivated via an activation message 215. The activation message 215 may include an activation status or a deactivation status for each configured CSI-RS resource set. Additionally, if the UE 115 is configured with a NZP-CSI-RS, the activation message 215 may include an activation or deactivation status for one or more transmission configuration indicator (TCI) states. As shown in FIG. 2, the UE 115-a may be configured with one or more of a ZP-CSI-RS or a NZP-CSI-RS. As such, the activation message 215 sent to the UE 115-a may include an activation status or deactivation status for a configured CSI-RS resource set (e.g., a CSI-RS resource set ID), whereas the activation message sent to the UE 115-b may include an activation status or deactivation status for a configured CSI-RS resource set as well as an activation or deactivation status for a configured TCI state (e.g., TCI state ID). If the activation message 215 indicates to activate a CSI-RS resource set, the UE 115-a will operate according to the received CSI-RS configuration (e.g., in the case of a NZP-CSI-RS, the UE 115 may assume that the CSI-RS transmission will occur on the activated set of resources). If the activation message 215 indicates to deactivate the CSI-RS resource set, the UE 115-a will not operate according to the CSI-RS configuration (e.g., in the case of a NZP-CSI-RS, the UE 115 may assume that the CSI-RS transmission will not occur on the activated set of resources). For unicast communication, the UE 115 may receive the activation message 215 via a MAC CE carried by a unicast PDSCH. Unicast PDSCH may refer to data signaling intended for a single UE 115 (e.g., the UE 115-a or the UE 115-b). As such, the resources allocated for such control signaling are located within a dedicated BWP 225 of the UE 115.

Upon receiving an activation message 215 that activates a CSI-RS resource set, the UE 115 may initiate rate matching for the unicast PDSCH around the activated CSI-RS resource set. In some examples, the UE 115 may initiate rate matching after transmitting feedback information (e.g., acknowledgement (ACK) feedback) to the base station 105-a regarding the received unicast data carrying the activation message 215. For example, the UE 115-a may start rate matching from a first slot after a particular time gap (e.g., 3 millisecond) after transmitting feedback information. Although CSI-RS handling protocols have been realized for unicast communication, such CSI-RS handling protocol have not been realized for multicast communication.

As described herein, the wireless communications system 200 may implement CSI-RS handling protocols for multicast communication. In some examples, the base station 105 may configure the UE 115 with one or more CSI resource sets for unicast and one or more CSI resource sets for multicast. In some examples, each CSI resource set may be assigned to a CSI resource set ID. In one example, each CSI resource set may be assigned to a unique CSI resource set ID. For example, if the CSI resource sets for unicast include a first resource set and a second resource set and the CSI resource sets for multicast include a third resource set and a fourth resource set, the first resource set may be assigned a resource set ID of one, the second resource set may be assigned a resource set ID of two, the third resource set may be assigned a resource set ID of three, and the fourth resource set may be assigned a resource set ID of four. CSI-RS resource sets with an ID of one and two are for unicast and CSI-RS resource sets with an ID of three and four are for multicast.

In such example, the activation message 215 may indicate to activate a CSI resource set for unicast and a CSI resource set for multicast via a MAC CE using unicast PDSCH signaling 210. The UE 115 may check the CSI-RS resource set IDs indicated in the activation message 215 and determine whether a CSI-RS resource set ID is for unicast or multicast based on the unique CSI-RS resource set ID. For example, if the activation message 215 indicates resource set IDs of one and four, the UE 115-a may perform rate matching around resources of the first resource set for unicast PDSCH and perform rate matching around resources of the fourth resource set for multicast PDSCH.

In another example, the CSI resource sets for unicast and the CSI resource sets for multicast may be assigned to one or more of a same CSI resource set ID. For example, if the CSI resource sets for unicast includes a first resource set and a second resource and the CSI resource sets for multicast includes a third resource set and a fourth resource set, the first resource set may be assigned a CSI-RS resource set ID of one, the second resource set may be assigned a resource set ID of two, the third resource set may be assigned a resource set ID of one, and the fourth resource set may be assigned a resource set ID of two. In such example, the activation message 215 may indicate to activate a CSI resource set ID for unicast via a MAC CE carried in unicast PDSCH signaling 210 and a second activation message 215 may indicate to activate a CSI resource set ID for multicast via a MAC CE carried in multicast PDSCH signaling 210. The UE 115 may identify whether the activated CSI-RS resource set is for multicast or unicast based on whether the MAC CE is carried in unicast PDSCH signaling 210 or multicast PDSCH signaling 210. For example, if the activation message 215 indicates a CSI-RS resource set ID of one the UE 115 may perform rate matching around resources of the first resource set for unicast PDSCH signaling 210 and if the second activation message 215 indicates a resource set ID of one, the UE 115 performs rate matching around resources of the third resource set for multicast PDSCH signaling 210.

Alternatively, the activation message 215 may indicate to activate a CSI resource set ID for unicast and a CSI resource set ID for multicast via a single MAC CE in the unicast PDSCH signaling 210. If activation message 215 indicates a CSI resource set ID that is configured for both unicast and multicast, the UE 115 may activate corresponding resource sets for unicast and multicast. For example, if the activation message 215 indicates a CSI-RS resource set ID of two, the UE 115 may perform rate matching around resources of the second resource set for unicast PDSCH and perform rate matching around resources of the fourth resource set for multicast PDSCH because both the second resource set and the fourth resources set correspond to a CSI-RS resource set ID of two. As another example, the activation message 215 may additionally indicate a BWP ID corresponding to each CSI-RS resource set ID. A BWP ID may be assigned to each dedicated BWP 225 (e.g., the BWP 225-a and the BWP 225-b) and additionally, a BWP ID may be assigned to the CFR 230. As an example, the dedicated BWP may be identified by a BWP ID of one and the CFR may be identified by a BWP ID of two. The UE 115 may identify whether the activated CSI-RS resource set is for unicast or multicast based on the CSI-RS resource set ID and the corresponding BWP ID. For example, if the activation message 215 indicates a CSI-RS resource set ID of one and a corresponding BWP ID of one, the UE 115 may perform rate matching around resource of the first resource set for unicast PDSCH signaling 210 and if the second activation message indicates a resource set ID of one and a corresponding BWP ID of 2, the UE 115 performs rate matching around resources of the third resource set for multicast PDSCH signaling 210.

In some examples, the UE 115 may apply the activation message 215 and perform rate matching for the multicast PDSCH a duration after receiving signaling over resources of the multicast PDSCH that carries the activation message 215. In one example, upon receiving the multicast PDSCH signaling 210 that carries the activation message 215, the UE 115-a may transmit feedback information (e.g., ACK feedback) related to the multicast PDSCH signaling 210. In some examples, the UE 115-a may transmit the feedback information to the base station 105-a based on a K1 value. The K1 value may indicate a number of slots between a last slot used to receive the PDSCH signaling and a first slot used to transmit the feedback information. Upon transmitting the feedback information, the UE 115 may wait a time gap (e.g., 3 milliseconds) and initiate rate matching for the multicast PDSCH from the first slot after the time gap (e.g., 3 milliseconds). In another example, the UE 115 may or may not be configured to provide feedback information. In such case, upon receiving the multicast PDSCH signaling, the UE 115 may initiate rate matching from the first slot after a time gap (e.g., 3 millisecond) plus T_{proc,1} or the time duration corresponding to N1 OFDM symbols. T_{proc,1} may be the minimum necessary processing time of the multicast PDSCH that corresponds to a minimum necessary time gap between the multicast PDSCH and the resource used for transmitting the feedback information. N1 may be the number of OFDM symbols that represents the minimum necessary processing time of the multicast PDSCH. In another example, the UE 115 may not be configured to provide feedback to the base station 105-a. In such example, the UE 115-a may begin rate matching from the first slot after a time gap (e.g., 3 milliseconds) after receiving signaling over the multicast PDSCH. The methods as described herein may provide a CSI-RS handling protocol for multicast.

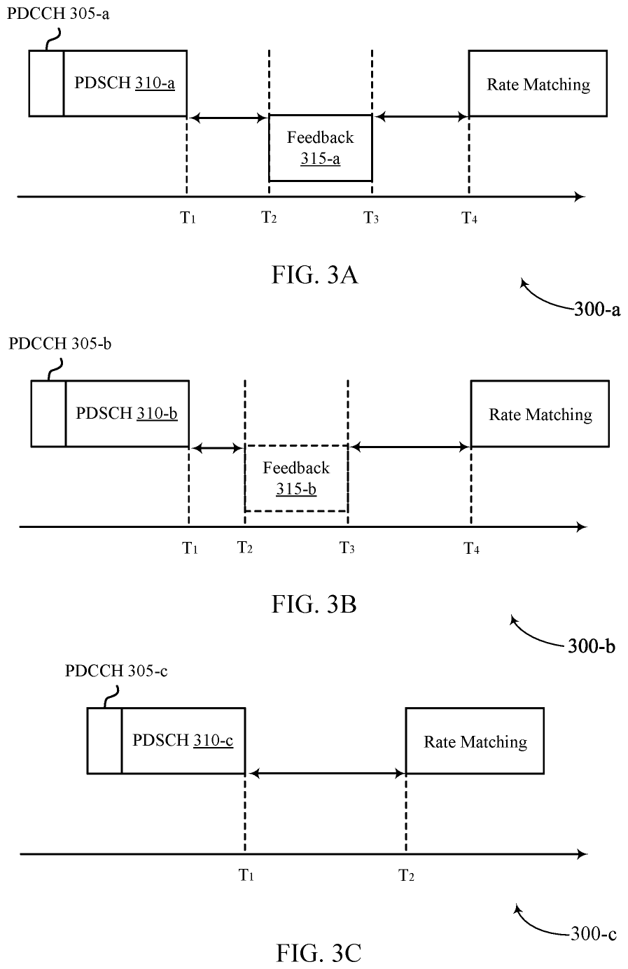

FIGS. 3A, 3B, and 3C illustrate examples of an activation timing diagram 300 (e.g., an activation timing diagram 300-a, an activation timing diagram 300-b, and an activation timing diagram 300-c) that supports semi-persistent CSI-RS handling for multicast in accordance with aspects of the present disclosure. In some examples, the activation timing diagram 300-a, the activation timing diagram 300-b, and the activation timing diagram 300-c may be implemented by aspects of a wireless communications system 100 and a wireless communications system 200. For example, the activation timing diagram 300-a, the activation timing diagram 300-b, and the activation timing diagram 300-c may be implemented by a base station 105 and a UE 115 as described with reference to FIGS. 1 and 2.

As described in FIG. 2, a UE may receive an activation command from the base station to activate a SP CSI-RS. For multicast, the UE may receive the activation command via a MAC CE carried in multicast PDSCH signaling or unicast PDSCH signaling. Multicast PDSCH signaling may refer to data signaling that is intended for more than one UE. A multicast PDSCH signal may be scheduled by DCI with a CRC that is scrambled by a common RNTI (e.g., a G-RNTI or a G-CS-RNTI) or in the case of SPS, the multicast PDSCH signal may be activated by a DCI with a CRC that is scrambled with the common RNTI. In some examples, the resources allocated for the multicast PDSCH signaling may be located within a CFR (e.g., a set of resources that is common to more than one UE or common to more than one dedicated BWP) and some higher layer configurations for the multicast PDSCH may be provided in the CFR configuration.

Unicast PDSCH signaling may refer to data signaling that intended for a single UE. A unicast PDSCH signal may be scheduled by DCI with a CRC that is scrambled by a dedicated RNTI (e.g., a cell RNTI (C-RNTI), modulation coding scheme RNTI (MCS-C-RNTI), or a configured scheduling RNTI (CS-RNTI)) or in the case of SPS, the unicast PDSCH signal may be activated by a DCI with a CRC that is scrambled with the dedicated RNTI. Higher layer configurations for the unicast PDSCH signal may be provided in a PDSCH configuration, a DL BWP configuration, or a serving cell configuration. The PDCCH 305 and the PDSCH 310, as illustrated in FIG. 3, may be an example of a multicast PDCCH 305 (e.g., a PDCCH 305-a, a PDCCH 305-b, and a PDCCH 305-c) and a multicast PDSCH 310.

In the example of FIGS. 3A, 3B, and 3C, the UE may receive the activation command via a MAC CE that is carried in the PDSCH 310. In some examples, the activation command may indicate for the UE to activate a CSI-RS resource set for multicast communications. Activating the CSI-RS resource set may allow the UE to operate according to a received CSI-RS configuration for the activated CSI-RS resource set. The CSI-RS configuration may indicate whether the CSI-RS is a NZP-CSI-RS or ZP-CSI-RS. In addition, the configuration may indicate a corresponding CSI-RS periodicity. Upon activating the CSI resource set indicated in the activation command, the UE may initiate rate matching around resources of the activated CSI-RS resource set. The activation timing diagrams 300 may illustrate three different times at which the UE may apply the activation command and initiate rate matching around the activated CSI-RS resource set. Rate matching may allow the UE and the base station to account for the resources that are not available for PDSCH signaling (e.g., resources allocated for activated CSI-RS).

In FIG. 3A, the UE may receive data signaling over resources of the multicast PDSCH 310-a. The data signaling may include at least an activation command for activating a CSI-RS resource set for multicast communication. In some examples, the UE may be configured to report feedback 315-a (e.g., HARQ ACK feedback) for multicast following reception of the PDSCH signaling at T₁. As such, the UE may report feedback 315-a for the data signaling received over resource of the PDSCH 310-a at T₂. In some examples, the UE may not immediately report the feedback information to the base station, but may wait a first duration before reporting the feedback information to the base station. The first duration may refer to a time between T₁ and T₂ and may be based on a parameter K1. The value of K1 may be a number of slot between a last slot used to transmit PDSCH signaling and a first slot used to transmit the feedback 315-a. The UE may transmit the feedback from T₂ to T₃.

After transmitting the feedback 315-a at T₃, the UE may activate the CSI-RS resources set indicated in the activation command and perform rate matching on a PDSCH around the resources of the activated CSI-RS resource set at T₄. In some examples, the UE may not immediately apply the activation command and perform the rate matching, but may wait a second duration. The second duration may refer to a time between T₃ and T₄. In some examples, the second duration may be a threshold number of subframes, slots, or milliseconds. As one example, the UE may start PDSCH rate matching from a first slot after a slot n+3N, where n is a slot index that UE transmits the feedback 315-a and N is a number of slots for 1 milliseconds. That is, the second duration may be equal to 3 milliseconds.

In FIG. 3B, the UE may receive data signaling over resources of the multicast PDSCH 310-b. The data signaling may include at least an activation command for activating a CSI-RS resource set for multicast communication. In some examples, the UE may not be configured to report feedback 315-a (e.g., HARQ ACK feedback) for multicast following reception of the PDSCH signaling at T₁. As such, the UE may optionally report feedback 315-a for the data signaling received over resources of the PDSCH 310-b at T₂. In some examples, the UE may not immediately report the feedback information to the base station, but may wait a first duration before optionally reporting the feedback information to the base station. The first duration may refer to a time between T₁ and T₂ and may be based on a parameter T_{proc} or a time corresponding to N1 OFDM symbols. The value of T_{proc} and the value corresponding to N1 OFDM symbols may represent a minimum time for processing the PDSCH 310-b and a minimum time gap between reception of the PDSCH signaling and the potential feedback occasion for the PDSCH 310-b. The UE may potentially transmit the feedback from T₂ to T₃.

After potentially transmitting the feedback 315-b at T₃, the UE may activate the CSI-RS resources set indicated in the activation command and perform rate matching on a PDSCH around the resources of the activated CSI-RS resource set at T₄. In some examples, the UE may not immediately apply the activation command and perform the rate matching, but may wait a second duration. The second duration may refer to a time between T₃ and T₄. In some examples, the second duration may be a threshold number of subframes, slots, or milliseconds. In one example, the second duration may be equal to 3 milliseconds.

In FIG. 3C, the UE may receive data signaling over resources of the multicast PDSCH 310-c. The data signaling may include at least an activation command for activating a CSI-RS resource set for multicast communication. In some examples, the UE may not be configured to report feedback (e.g., HARQ ACK feedback) for multicast following reception of the PDSCH signaling at T₁. In such case, the UE may not account for timing discrepancies associated with feedback transmission. As such, following the reception of the PDSCH signaling at T₁, the UE may apply the activation command and perform rate matching on the PDSCH 310-c around the resources of the activated CSI-RS resource set at T₂. In some examples, the UE may not immediately activate the CSI-RS resource set and perform the rate matching, but may wait a first duration before performing the rate matching. The first duration may refer to a time between T₁ and T₂. In some examples, the second duration may be a threshold number of subframes, slots, or milliseconds. In one example, the first duration may be equal to 3 milliseconds (e.g., three subframes of 1 millisecond).

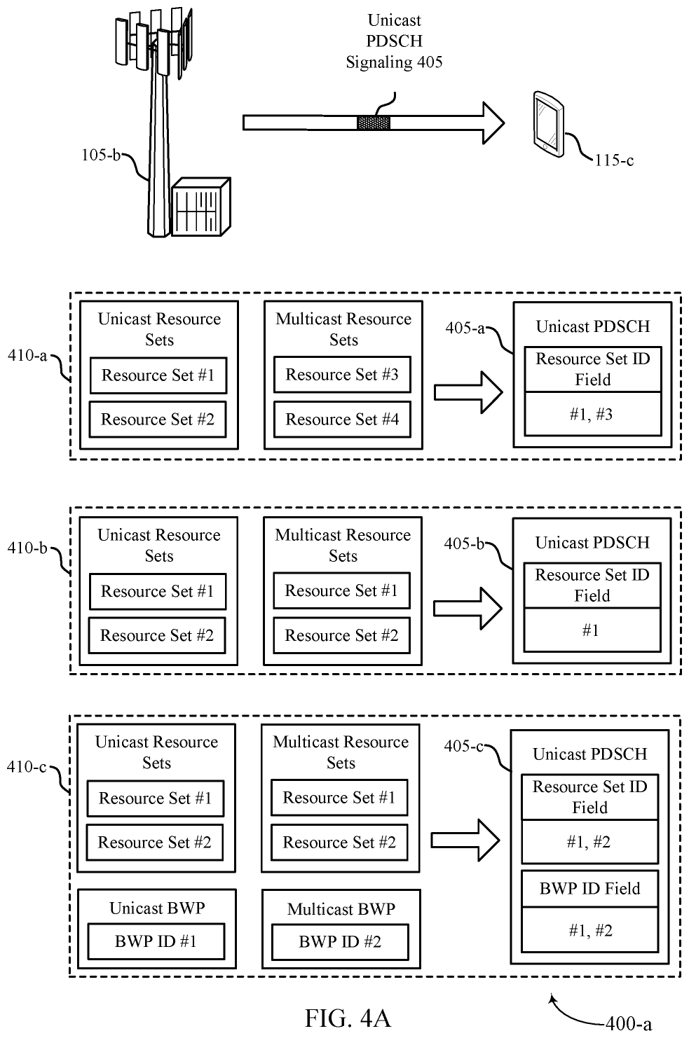

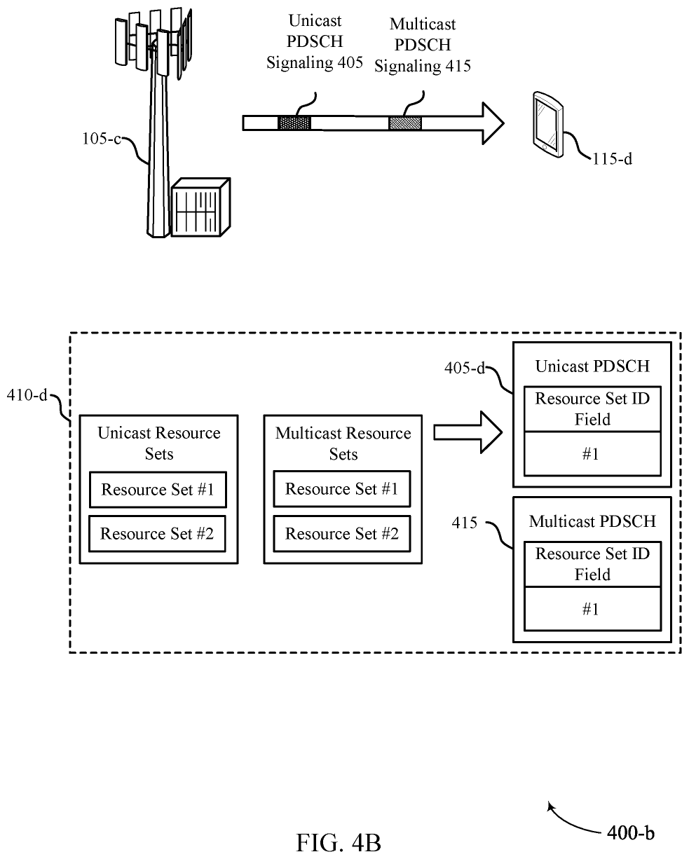

FIGS. 4A and 4B illustrate examples of an activation scheme 400 (e.g., an activation scheme 400-a and an activation scheme 400-b) that supports semi-persistent CSI-RS handling for multicast in accordance with aspects of the present disclosure. In some examples, the activation scheme 400-a and the activation scheme 400-b may be implemented by aspects of a wireless communications system 100 and a wireless communications system 200. For example, the activation scheme 400-a and the activation scheme 400-b may be implemented by a base station 105 and a UE 115 as described with reference to FIGS. 1 and 2.

As described herein, a base station 105 may transmit signaling indicating a CSI-RS configuration to the UE 115. The CSI-RS configuration may indicate a type of CSI-RS. For examples, the CSI-RS configuration may indicate for the UE to utilize a NZP-CSI-RS or a ZP-CSI-RS. In addition, the CSI-RS configuration may indicate multiple CSI-RS resource sets (e.g., sets of resources that are allocated for the CSI-RS). The multiple CSI-RS resource sets may include CSI-RS resource sets for multicast and CSI-RS resource sets for unicast. As an example, the CSI-RS resources sets for unicast may include a first resource set and a second resource set and the CSI-RS resources sets for multicast may include a third resource set and a fourth resource set.

To activate a CSI-RS resource set for multicast and a CSI-RS resource set for unicast, the base station 105 may transmit an activation command to the UE 115. In the example of activation scheme 400-a, the base station 105-b may transmit an activation command to the UE 115-c for activation of the CSI-RS resource set for multicast via unicast PDSCH signaling 405. As described in FIG. 3, unicast PDSCH signaling 405 may refer to data signaling intended for a single UE (e.g., scheduled by a DCI with a CRC that is scrambled by a UE-specific RNTI).

In FIG. 4A, the activation scheme 400-a may implement one of three different command designs 410 (e.g., a command design 410-a, a command design 410-b, and a command design 410-c). The command designs 410 illustrate different ways the UE may differentiate between CSI-RS resource sets for multicast and unicast indicated in the activation command. In command design 410-a, each resource set of the multiple resource sets configured for the UE may be assigned a unique CSI-RS resource set ID. That is, one resource set ID may be assigned to either a CSI-RS resource set configured for unicast or a CSI-RS resource set configured for multicast, but a same CSI-RS resource set ID may not be assigned to both of the CSI-RS resource set configured for unicast and the CSI-RS resource set configured for multicast.

As an example, the first resource set (e.g., configured for unicast) may be assigned with a CSI-RS resource set ID of one and the second resource set (e.g., configured for unicast) may be assigned with a CSI-RS resource set ID of two. Additionally, the third resource set (e.g., configured for multicast) may be assigned with a CSI-RS resources set ID of three and the fourth resource set (e.g., configured for multicast). The base station 105-b may select a CSI-RS resource set for unicast and a CSI-RS resource set for multicast and include an indication of the selected CSI-RS resource set in the activation command. The activation command may be indicated to the UE 115-c using a MAC CE carried in the unicast PDSCH signaling 405-a. In one example, the base station 105-b may select the first resource set and the third resource set and as such, may include a CSI-RS resource set ID of one and a CSI-RS resource set ID of three in the activation command.

The UE 115-c may receive the activation command and determine what CSI-RS resource set to activate for unicast and multicast based on the unique CSR-RS resource set IDs. As an example, the UE 115-c may identify to activate the first resource set for unicast and the third resource set for multicast based on the activation command including CSI-RS resource set IDs of one and three. Upon activation, the UE 115-c may rate match around resources of the third resource set for multicast PDSCHs in the CFR of a serving cell of the UE 115-c but not for unicast PDSCHs. Additionally, the UE 115-c may rate match around resources of the first resource set for unicast PDSCHs in a BWP of the serving cell of the UE 115-c but not for multicast PDSCHs.

In command design 410-b, a same CSI-RS resource set ID may be assigned to a resource set configured for unicast and a resource set configured for multicast. As an example, the first resource set (e.g., configured for unicast) may be assigned with a CSI-RS resource set ID of one and the second resource set (e.g., configured for unicast) may be assigned with a CSI-RS resource set ID of two. Additionally, the third resource set (e.g., configured for multicast) may be assigned with a CSI-RS resources set ID of one and the fourth resource set (e.g., configured for multicast) may be assigned a CSI-RS resource set ID of two. The base station 105-b may select a CSI-RS resource set for unicast and a CSI-RS resource set for multicast and include an indication of the selected CSI-RS resource set in the activation command. The activation command may be indicated to the UE 115-c using a MAC CE carried in the unicast PDSCH signaling 405-b. In one example, the base station 105-b may select the first resource set and the third resource set and as such, may include a CSI-RS resource set ID of one.

The UE 115-c may receive the activation command and determine what CSI-RS resource set to activate for unicast and multicast based on the CSR-RS resource set IDs. If the UE 115-c receives the command indicating CSI-RS resource set ID that is assigned to a resource set configured for unicast and a resource set configured for multicast, the UE 115-c may activate rate matching around the resource set for unicast and the resource set for multicast. For example, because the CSI-RS resource set ID of one is assigned to a resource set configured for unicast (e.g., the first resource set) and a resource set configured for multicast (e.g., the third resource set), the UE 115-c may rate match around resources of the corresponding resources sets for multicast PDSCHs and unicast PDSCHs. As an example, the UE 115-c may identify to activate the first resource set for unicast and the third resource set for multicast based on the activation command including CSI-RS resource set IDs of one. Upon activation, the UE 115-c may rate match around resources of the third resource set for multicast PDSCHs in the CFR of a serving cell of the UE 115-c but not for unicast PDSCHs. Additionally, the UE 115-c may rate match around resources of the first resource set for unicast PDSCHs in a BWP of the serving cell of the UE 115-c but not for multicast PDSCHs.

Similar to command design 410-b, in command design 410-c, a same CSI-RS resource set ID may be assigned to a resource set configured for unicast and a resource set configured for multicast. As an example, the first resource set (e.g., configured for unicast) may be assigned with a CSI-RS resource set ID of one and the second resource set (e.g., configured for unicast) may be assigned with a CSI-RS resource set ID of two. Additionally, the third resource set (e.g., configured for multicast) may be assigned with a CSI-RS resources set ID of one and the fourth resource set (e.g., configured for multicast) may be assigned a CSI-RS resource set ID of two. Additionally, a unique BWP ID may be assigned for unicast and multicast. For example, unicast may be assigned a BWP ID of one and multicast may be assigned a BWP ID of two. The BWP ID for multicast may correspond to the CFR and may be different from the BWP IDs of dedicated BWPs (e.g., a BWP of the UE 115-c).

The base station 105-b may select a CSI-RS resource set for unicast and a CSI-RS resource set for multicast and include an indication of the selected CSI-RS resource set in the activation command along with a corresponding BWP ID. The activation command may be indicated to the UE 115-c using a MAC CE carried in the unicast PDSCH signaling 405-c. In one example, the base station 105-b may select the first resource set and the fourth resource set and as such, may include a CSI-RS resource set ID of one and a corresponding BWP ID of one in the activation command. Additionally, the base station 105-b may include a CSI-RS resource set ID of two and a corresponding BWP ID of two in the activation command. Upon activation, the UE 115-c may rate match around resources of the fourth resource set for multicast PDSCHs in the CFR of a serving cell of the UE 115-c but not for unicast PDSCHs. Additionally, the UE 115-c may rate match around resources of the first resource set for unicast PDSCHs in a BWP of the serving cell of the UE 115-c but not for multicast PDSCHs.

In the example of activation scheme 400-b, the base station 105-c may transmit an activation command for activation of the CSI-RS resource set for multicast via a multicast PDSCH signaling 415. As described in FIG. 3, multicast PDSCH signaling may refer to data signaling intended for multiple UEs (e.g., scheduled by a DCI with a CRC that is scrambled by a common RNTI).

In FIG. 4B, the activation scheme 400-b may implement a command design 410-d. The command design 410 may illustrate a way that the UE may differentiate between CSI-RS resource sets for multicast and unicast. Similar to the command design 410-b, in the command design 410-d, a same CSI-RS resource set ID may be assigned to a resource set configured for unicast and a resource set configured for multicast. As an example, the first resource set (e.g., configured for unicast) may be assigned with a CSI-RS resource set ID of one and the second resource set (e.g., configured for unicast) may be assigned with a CSI-RS resource set ID of two. Additionally, the third resource set (e.g., configured for multicast) may be assigned with a CSI-RS resources set ID of one and the fourth resource set (e.g., configured for multicast) may be assigned a CSI-RS resource set ID of two.

The base station 105-c may select a CSI-RS resource set for unicast and include the selected CSI-RS resource set for unicast in the activation command. The activation command may be indicated to the UE 115-d using a MAC CE carried in the unicast PDSCH signaling 405-d. Additionally, the base station 105-c may select a CSI-RS resource set for unicast and include the selected CSI-RS resource set for multicast in the activation command. The activation command may be indicated to the UE 115-d using a MAC CE carried in the multicast PDSCH signaling 415. In one example, the base station 105-c may select the first resource set and the third resource set and as such, may include a CSI-RS resource set ID of one in the activation command carried in multicast PDSCH signaling 415 and the activation command carried in PDSCH signaling 405-d.

The UE 115-d may receive activation command carried in multicast PDSCH signaling 415 and the activation command carried in PDSCH signaling 405-d and determine what CSI-RS resource set to activate for unicast and multicast based on whether the MAC CE is carried in unicast or multicast. For example, upon receiving the activation command carried in multicast PDSCH signaling 415, the UE 115-d may rate match around resources of the third resource set for multicast PDSCHs in the CFR of a serving cell of the UE 115-d but not for unicast PDSCHs. Additionally, upon receiving the activation command carried in unicast PDSCH signaling 405-d, the UE 115-d may rate match around resources of the first resource set for unicast PDSCHs in a BWP of the serving cell of the UE 115-d but not for multicast PDSCHs.

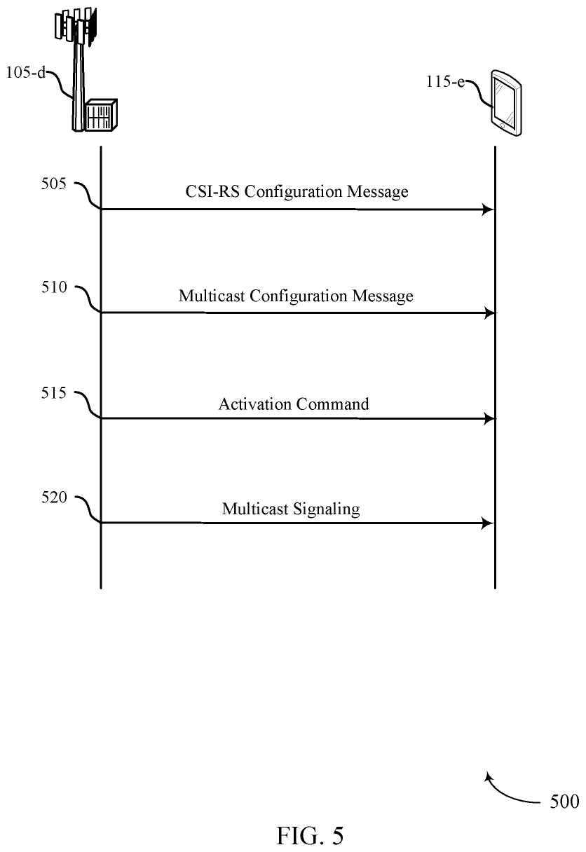

FIG. 5 illustrates an example of a process flow 500 that supports semi-persistent CSI-RS handling for multicast in accordance with aspects of the present disclosure. In some examples, the process flow 500 may implement or be implemented by aspects of a wireless communications system 100 and a wireless communications system 200. For example, the process flow 500 may include a base station 105-d and a UE 115-e which may be example of a base station 105 and a UE 115 as described with reference to FIGS. 1, 2, 4A, and 4B. Alternative examples of the following be implemented, where some steps are performed in a different order than described or are not performed at all. In some cases, steps may include additional features not mentioned below, or further steps may be added.

At 505, the base station 105-d may transmit a first message indicating a configuration for a SP CSI-RS to the UE 115-e. In some examples, the configuration may indicate a periodicity associated with the CSI-RS. Additionally, the configuration may indicate resources over which to receive the CSI-RS. The SP CSI-RS may include a NZP-CSI-RS or a ZP-CSI-RS.

At 510, the base station 105-d may transmit a second message indicating a configuration for multicast communication to the UE 115-e. In some examples, multicast communication may take place over a first set of resources of a multicast downlink shared channel. In some examples, the first set of resources may be included in a first BWP allocated to the UE 115-e and a second BWP allocated to a UE 115 different from the UE 115-e.

At 515, the base station 105-d may transmit an activation command to the UE 115-e. The activation command may indicate to activate a subset of the first set of resources for the SP CSI-RS for multicast communication. In some examples, the UE 115-e may receive the activation command via a MAC CE carried by the multicast downlink channel. The multicast downlink channel may be scheduled by a DCI format having a CRC scrambled by a G-RNTI or a G-CS-RNTI or activated by a DCI format having a CRC scrambled by a G-RNTI or a G-CS-RNTI. The multicast downlink shared channel may be configured by a downlink shared channel multicast configuration or a CFR configuration. In the case that the activation command is carried by the multicast downlink shared channel, the UE 115-d may identify that the subset of the first set of resources is a multicast resource set based on a resource set ID being included in the activation command. In some examples, the UE 115-d may refrain from rate-matching around a unicast resource set based on the resource set ID being included in the activation command.

In another example, the UE 115-e may receive the activation command via MAC CE carried by a unicast downlink channel. The unicast downlink channel may be scheduled a DCI format having a CRC scrambled by a C-RNTI, MSC-RNTI, or a CS-RNTI or activated by a DCI format having a CRC scrambled by a C-RNTI, MSC-RNTI, or a CS-RNTI. The unicast downlink shared channel may be configured by a downlink shared channel unicast configuration, a downlink shared channel configuration, a downlink BWP configuration, or a serving cell configuration. In the case that the activation message is carried by the multicast downlink shared channel, the UE 115-d may identify that the subset of the first set of resources is a multicast resource set based on a resource set ID being included in the activation command, where the resource set ID is uniquely mapped to the multicast resource set. In some examples, the UE 115-d may refrain from rate-matching around a unicast resource set based on the resource set ID being uniquely mapped to the multicast resource set.

Alternatively, the UE 115-d may identify that the subset of the first set of resources is a multicast resource set and a second subset of a second set of resources is a unicast resource set based on a resource set ID being included in the activation command, where the resource set ID is mapped to both the multicast resource set and the unicast resource set. Alternatively, the UE 115-d may identify that the subset of the first set of resources is a multicast resource set based on a BWP ID being included in the activation command, where the BWP ID is associated with the first set of resources that are included in the first BWP and second BWP.

At 520, the UE 115-d may receive multicast signaling from the base station 105-d by rate-matching around the subset of the first set of resources. In some examples, the UE 115-d may delay the rate-matching and application of the activation command. As such, the UE 115-d may determine an activation delay for application of the activation command. The activation delay may be three milliseconds after a HARQ feedback opportunity responsive to a downlink shared channel carrying the activation command. In another example, the activation delay may be three milliseconds after a minimum processing timing for a HARQ feedback opportunity response to the downlink shared channel carrying the activation command. In another example, the activation delay may be three milliseconds after the downlink shared channel carrying the activation command.

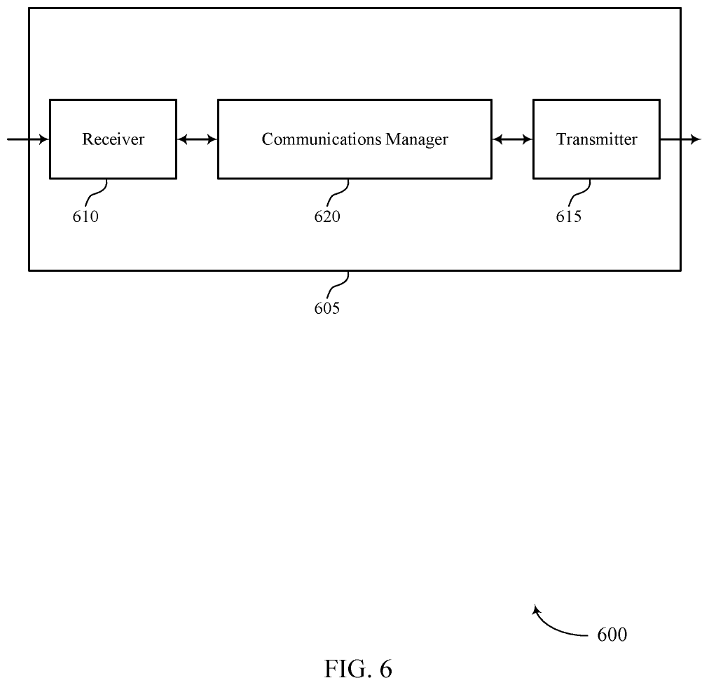

FIG. 6 shows a block diagram 600 of a device 605 that supports semi-persistent CSI-RS handling for multicast in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to semi-persistent CSI-RS handling for multicast). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to semi-persistent CSI-RS handling for multicast). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of semi-persistent CSI-RS handling for multicast as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a first UE in accordance with examples as disclosed herein. For example, the communications manager 620 may be configured as or otherwise support a means for receiving, from a base station, a first message indicating a first configuration for a CSI-RS resource set to be activated by an activation command, where the CSI-RS resource set is for a CSI-RS, the CSI-RS including a NZP-CSI-RS or a ZP-CSI-RS. The communications manager 620 may be configured as or otherwise support a means for receiving, from the base station, a second message indicating a second configuration for use by the first UE for multicast signaling via a multicast downlink shared channel over a first set of resources that are included in a first BWP allocated to the first UE for receiving the multicast signaling. The communications manager 620 may be configured as or otherwise support a means for receiving, from the base station, the activation command activating the CSI-RS resource set. The communications manager 620 may be configured as or otherwise support a means for receiving the multicast signaling from the base station by rate-matching, based on the activation command, around a subset of the first set of resources, where the subset is allocated for the CSI-RS.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for more efficient utilization of communication resources. The methods as described herein may allow for a device 605 to activate a CSI-RS resource set for multicast communication thus allowing for a more efficient use of communication resources.

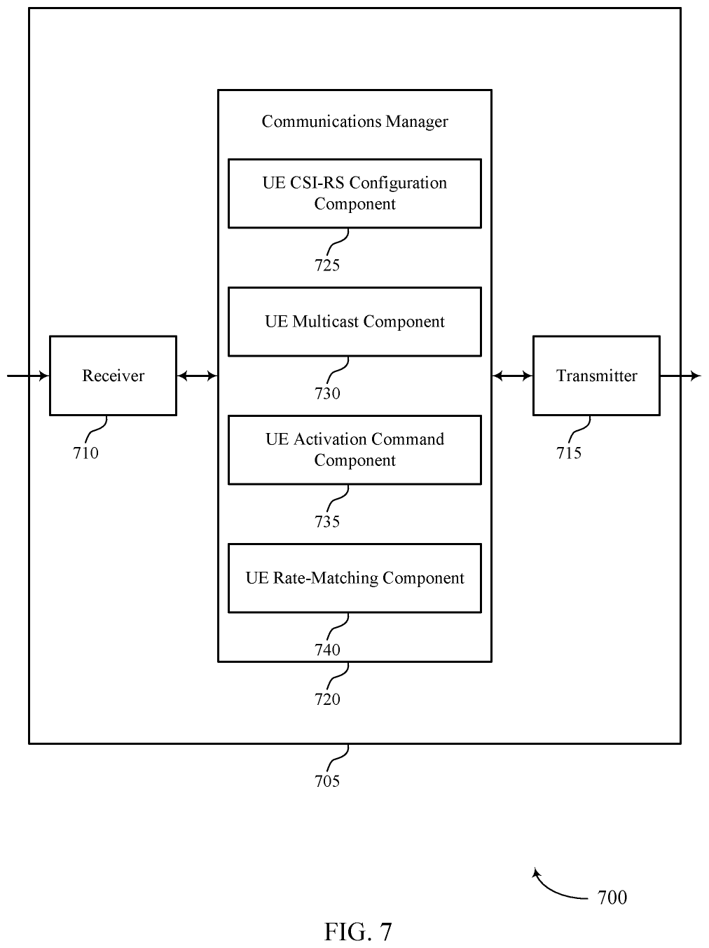

FIG. 7 shows a block diagram 700 of a device 705 that supports semi-persistent CSI-RS handling for multicast in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to semi-persistent CSI-RS handling for multicast). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to semi-persistent CSI-RS handling for multicast). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of semi-persistent CSI-RS handling for multicast as described herein. For example, the communications manager 720 may include a UE CSI-RS configuration component 725, a UE multicast component 730, a UE activation command component 735, a UE rate-matching component 740, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communications at a first UE in accordance with examples as disclosed herein. The UE CSI-RS configuration component 725 may be configured as or otherwise support a means for receiving, from a base station, a first message indicating a first configuration for a CSI-RS resource set to be activated by an activation command, where the CSI-RS resource set is for a CSI-RS, the CSI-RS including a NZP-CSI-RS or a ZP-CSI-RS. The UE multicast component 730 may be configured as or otherwise support a means for receiving, from the base station, a second message indicating a second configuration for use by the first UE for multicast signaling via a multicast downlink shared channel over a first set of resources that are included in a first BWP allocated to the first UE for receiving the multicast signaling. The UE activation command component 735 may be configured as or otherwise support a means for receiving, from the base station, the activation command activating the CSI-RS resource set. The UE rate-matching component 740 may be configured as or otherwise support a means for receiving the multicast signaling from the base station by rate-matching, based on the activation command, around a subset of the first set of resources, where the subset is allocated for the CSI-RS.

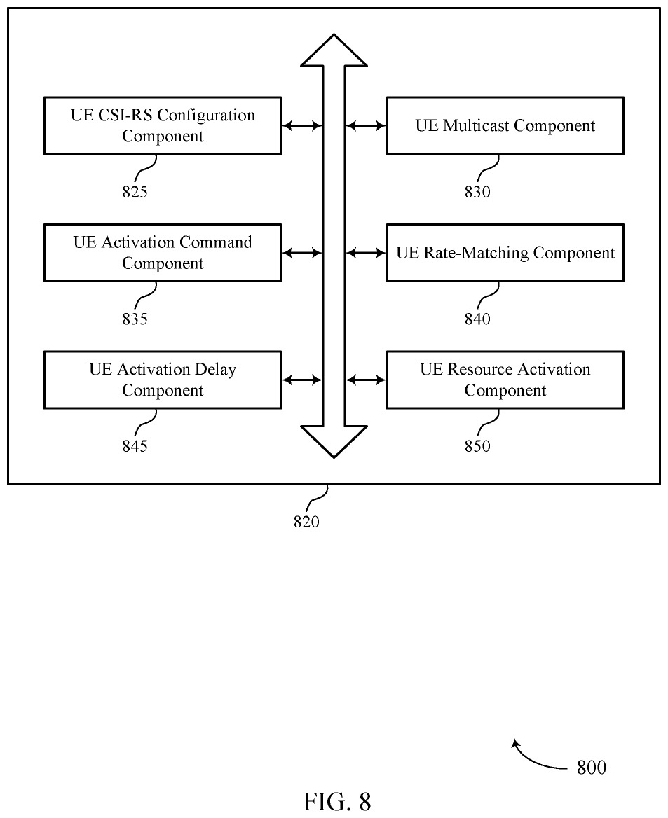

FIG. 8 shows a block diagram 800 of a communications manager 820 that supports semi-persistent CSI-RS handling for multicast in accordance with aspects of the present disclosure. The communications manager 820 may be an example of aspects of a communications manager 620, a communications manager 720, or both, as described herein. The communications manager 820, or various components thereof, may be an example of means for performing various aspects of semi-persistent CSI-RS handling for multicast as described herein. For example, the communications manager 820 may include a UE CSI-RS configuration component 825, a UE multicast component 830, a UE activation command component 835, a UE rate-matching component 840, a UE activation delay component 845, a UE resource activation component 850, or any combination thereof. Each of these components may communicate, directly or indirectly, with one another (e.g., via one or more buses).

The communications manager 820 may support wireless communications at a first UE in accordance with examples as disclosed herein. The UE CSI-RS configuration component 825 may be configured as or otherwise support a means for receiving, from a base station, a first message indicating a first configuration for a CSI-RS resource set to be activated by an activation command, where the CSI-RS resource set is for a CSI-RS, the CSI-RS including a NZP-CSI-RS or a ZP-CSI-RS. The UE multicast component 830 may be configured as or otherwise support a means for receiving, from the base station, a second message indicating a second configuration for use by the first UE for multicast signaling via a multicast downlink shared channel over a first set of resources that are included in a first BWP allocated to the first UE for receiving the multicast signaling. The UE activation command component 835 may be configured as or otherwise support a means for receiving, from the base station, the activation command activating the CSI-RS resource set. The UE rate-matching component 840 may be configured as or otherwise support a means for receiving the multicast signaling from the base station by rate-matching, based on the activation command, around a subset of the first set of resources, where the subset is allocated for the CSI-RS.

In some examples, to support receiving the activation command, the UE activation command component 835 may be configured as or otherwise support a means for receiving a MAC CE carried by the multicast downlink shared channel, the MAC CE including the activation command.

In some examples, the UE resource activation component 850 may be configured as or otherwise support a means for identifying the subset of the first set of resources as a multicast resource set for the CSI-RS based on a resource set ID included within the activation command and the MAC CE being carried by the multicast downlink shared channel.

In some examples, the UE resource activation component 850 may be configured as or otherwise support a means for refraining from rate-matching around a unicast resource set for the CSI-RS based on the MAC CE being carried by the multicast downlink shared channel.

In some examples, the multicast downlink shared channel is for multicast communications based on the multicast downlink shared channel being scheduled by a DCI format having an CRC scrambled by a G-RNTI or by a G-CS-RNTI, the multicast downlink shared channel being activated by a DCI format having a CRC scrambled by a G-CS-RNTI, or the multicast downlink shared channel being configured by a downlink shared channel multicast configuration or a CFR configuration.

In some examples, to support receiving the activation command, the UE activation command component 835 may be configured as or otherwise support a means for receiving a MAC CE carried by a unicast downlink shared channel, the MAC CE including the activation command.

In some examples, the UE resource activation component 850 may be configured as or otherwise support a means for identifying the subset of the first set of resources as a multicast resource set for the CSI-RS based on a resource set ID included within the activation command.

In some examples, the UE resource activation component 850 may be configured as or otherwise support a means for receiving a second activation command activating a second CSI-RS resource set, the second activation command received via a second MAC CE by the unicast downlink shared channel, identifying a subset of a second set of resources as a unicast resource set for a second CSI-RS based on a resource set ID included within the second activation command, and receive unicast signaling from the network device by rate-matching, based on the second activation command, around the subset of the second set of resources, where the subset is allocated for the second CSI-RS.

In some examples, the UE resource activation component 850 may be configured as or otherwise support a means for identifying the subset of the first set of resources as a multicast resource set for the CSI-RS and a second subset of a second set of resources as a unicast resource set for the CSI-RS, the identifying of both the subset and the second subset based on a resource set ID included within the activation command, the resource set ID mapped to both the multicast resource set and the unicast resource set.

In some examples, the UE resource activation component 850 may be configured as or otherwise support a means for identifying the subset of the first set of resources as a multicast resource set for the CSI-RS based on a BWP ID included within the activation command, the BWP ID being associated with the first set of resources.

In some examples, to support identifying the subset of the first set of resources, the UE resource activation component 850 may be configured as or otherwise support a means for identifying the subset of the first set of resources based on a resource set ID included within the activation command.

In some examples, the unicast downlink shared channel is for unicast communications based on the unicast downlink shared channel being scheduled by a DCI format having an CRC scrambled by a C-RNTI, by a MCS-C-RNTI, or by a CS-RNTI, the unicast downlink shared channel being activated by a DCI format having a CRC scrambled by a CS-RNTI, or the unicast downlink shared channel being configured by a downlink shared channel configuration, a downlink BWP configuration, or a serving cell configuration.

In some examples, the UE activation delay component 845 may be configured as or otherwise support a means for determining an activation delay for application of the activation command, the activation delay being a threshold duration after a HARQ feedback opportunity responsive to a downlink shared channel carrying the activation command.

In some examples, the UE activation delay component 845 may be configured as or otherwise support a means for determining an activation delay for application of the activation command, the activation delay being a threshold duration after a minimum possible timing for a HARQ feedback opportunity responsive to a downlink shared channel carrying the activation command.

In some examples, the UE activation delay component 845 may be configured as or otherwise support a means for determining an activation delay for application of the activation command, the activation delay being a threshold duration after a downlink shared channel carrying the activation command.

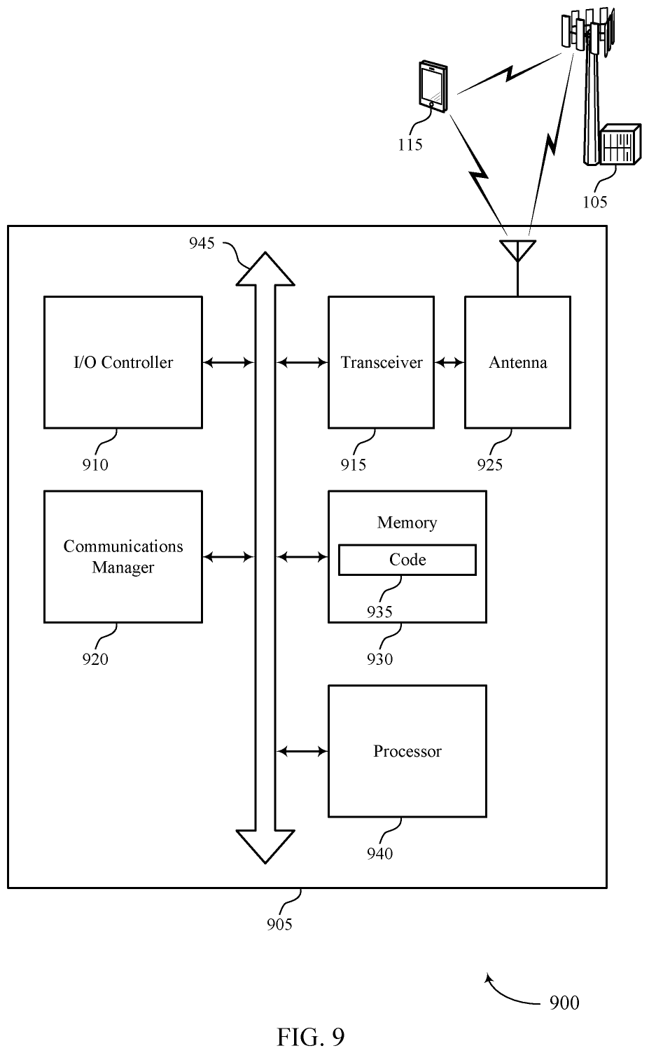

FIG. 9 shows a diagram of a system 900 including a device 905 that supports semi-persistent CSI-RS handling for multicast in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting semi-persistent CSI-RS handling for multicast). For example, the device 905 or a component of the device 905 may include a processor 940 and memory 930 coupled with or to the processor 940, the processor 940 and memory 930 configured to perform various functions described herein.

The communications manager 920 may support wireless communications at a first UE in accordance with examples as disclosed herein. For example, the communications manager 920 may be configured as or otherwise support a means for receiving, from a base station, a first message indicating a first configuration for a CSI-RS resource set to be activated by an activation command, where the CSI-RS resource set is for a CSI-RS, the CSI-RS including a NZP-CSI-RS or a ZP-CSI-RS. The communications manager 920 may be configured as or otherwise support a means for receiving, from the base station, a second message indicating a second configuration for use by the first UE for multicast signaling via a multicast downlink shared channel over a first set of resources that are included in a first BWP allocated to the first UE for receiving the multicast signaling. The communications manager 920 may be configured as or otherwise support a means for receiving, from the base station, the activation command activating the CSI-RS resource set. The communications manager 920 may be configured as or otherwise support a means for receiving the multicast signaling from the base station by rate-matching, based on the activation command, around a subset of the first set of resources, where the subset is allocated for the CSI-RS.

By including or configuring the communications manager 920 in accordance with examples as described herein, the device 905 may support techniques for improved communication reliability, more efficient utilization of communication resources, and improved coordination between devices. The methods as described may allow the device 905 to utilize CSI-RSs for multicast communications. CSI-RS may be used by the device 905 to perform channel measurements, where these channel measurement may be used by a base station and the device 905 to improve communication reliability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of semi-persistent CSI-RS handling for multicast as described herein, or the processor 940 and the memory 930 may be otherwise configured to perform or support such operations.

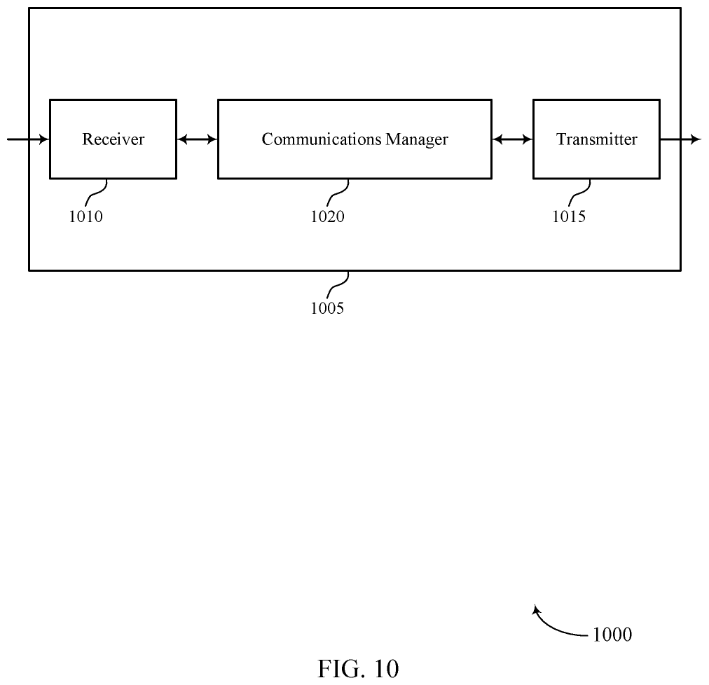

FIG. 10 shows a block diagram 1000 of a device 1005 that supports semi-persistent CSI-RS handling for multicast in accordance with aspects of the present disclosure. The device 1005 may be an example of aspects of a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to semi-persistent CSI-RS handling for multicast). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to semi-persistent CSI-RS handling for multicast). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of semi-persistent CSI-RS handling for multicast as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a base station in accordance with examples as disclosed herein. For example, the communications manager 1020 may be configured as or otherwise support a means for transmitting, to a first UE, a first message indicating a first configuration for a CSI-RS resource set to be activated by an activation command, where the CSI-RS resource set is for a CSI-RS, the CSI-RS including a NZP-CSI-RS or a ZP-CSI-RS. The communications manager 1020 may be configured as or otherwise support a means for transmitting, to the first UE, a second message indicating a second configuration for use by the first UE for multicast signaling via a multicast downlink shared channel over a first set of resources that are included in a first BWP allocated to the first UE for the multicast signaling and in a second BWP allocated to one or more second UEs for the multicast signaling. The communications manager 1020 may be configured as or otherwise support a means for transmitting, to the first UE, the activation command activating the CSI-RS resource set. The communications manager 1020 may be configured as or otherwise support a means for transmitting the multicast signaling to the first UE by rate-matching, based on the activation command, around a subset of the first set of resources, where the subset is allocated for the CSI-RS.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for more efficient utilization of communication resources.

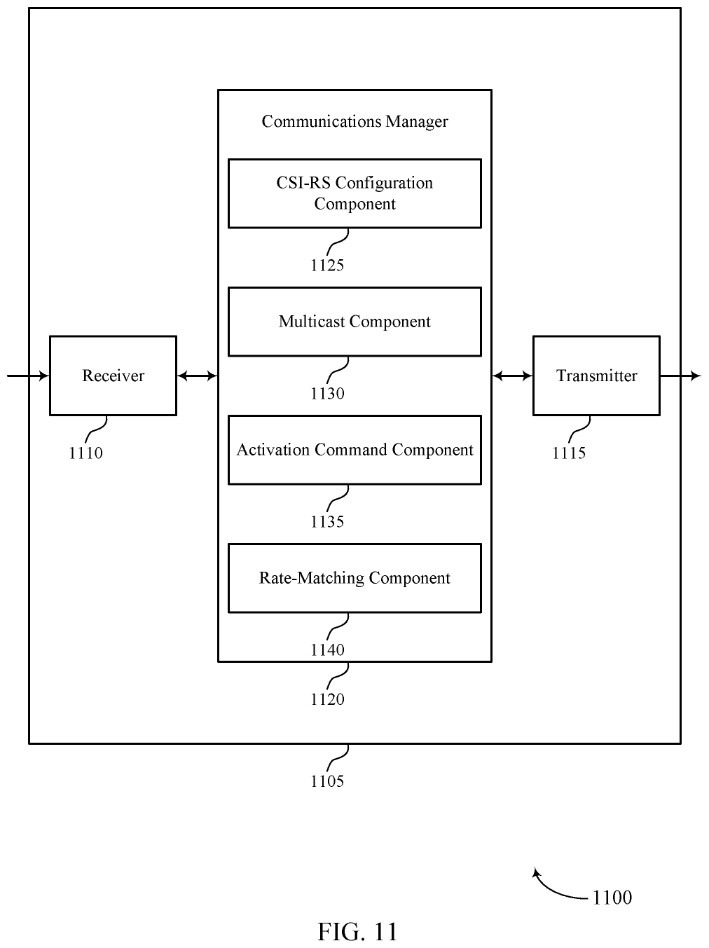

FIG. 11 shows a block diagram 1100 of a device 1105 that supports semi-persistent CSI-RS handling for multicast in accordance with aspects of the present disclosure. The device 1105 may be an example of aspects of a device 1005 or a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to semi-persistent CSI-RS handling for multicast). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to semi-persistent CSI-RS handling for multicast). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of semi-persistent CSI-RS handling for multicast as described herein. For example, the communications manager 1120 may include a CSI-RS configuration component 1125, a multicast component 1130, an activation command component 1135, a rate-matching component 1140, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communications at a base station in accordance with examples as disclosed herein. The CSI-RS configuration component 1125 may be configured as or otherwise support a means for transmitting, to a first UE, a first message indicating a first configuration for a CSI-RS resource set to be activated by an activation command, where the CSI-RS resource set is for a CSI-RS, the CSI-RS including a NZP-CSI-RS or a ZP-CSI-RS. The multicast component 1130 may be configured as or otherwise support a means for transmitting, to the first UE, a second message indicating a second configuration for use by the first UE for multicast signaling via a multicast downlink shared channel over a first set of resources that are included in a first BWP allocated to the first UE for the multicast signaling and in a second BWP allocated to one or more second UEs for the multicast signaling. The activation command component 1135 may be configured as or otherwise support a means for transmitting, to the first UE, the activation command activating the CSI-RS resource set. The rate-matching component 1140 may be configured as or otherwise support a means for transmitting the multicast signaling to the first UE by rate-matching, based on the activation command, around a subset of the first set of resources, where the subset is allocated for the CSI-RS.

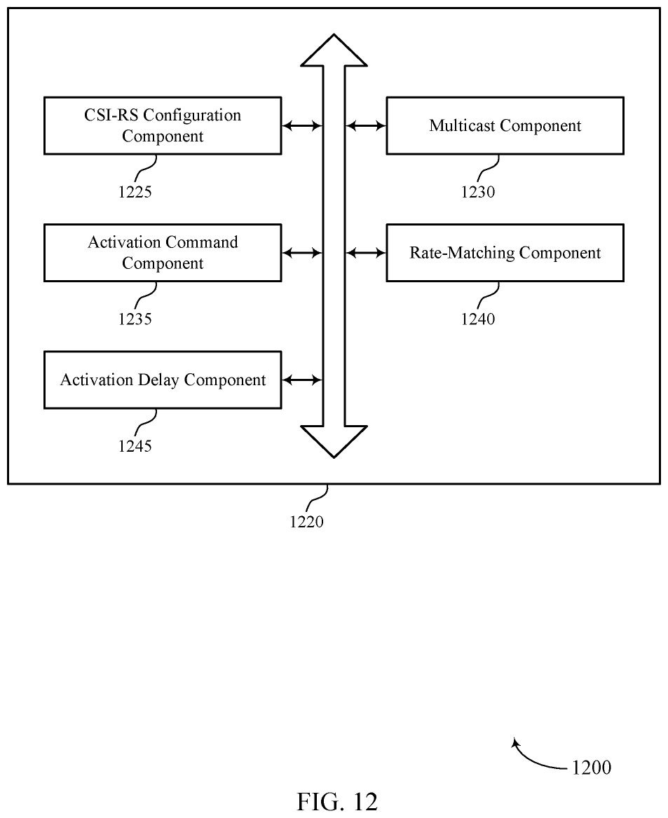

FIG. 12 shows a block diagram 1200 of a communications manager 1220 that supports semi-persistent CSI-RS handling for multicast in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of semi-persistent CSI-RS handling for multicast as described herein. For example, the communications manager 1220 may include a CSI-RS configuration component 1225, a multicast component 1230, an activation command component 1235, a rate-matching component 1240, an activation delay component 1245, or any combination thereof. Each of these components may communicate, directly or indirectly, with one another (e.g., via one or more buses).

The communications manager 1220 may support wireless communications at a base station in accordance with examples as disclosed herein. The CSI-RS configuration component 1225 may be configured as or otherwise support a means for transmitting, to a first UE, a first message indicating a first configuration for a CSI-RS resource set to be activated by an activation command, where the CSI-RS resource set is for a CSI-RS, the CSI-RS including a NZP-CSI-RS or a ZP-CSI-RS. The multicast component 1230 may be configured as or otherwise support a means for transmitting, to the first UE, a second message indicating a second configuration for use by the first UE for multicast signaling via a multicast downlink shared channel over a first set of resources that are included in a first BWP allocated to the first UE for the multicast signaling and in a second BWP allocated to one or more second UEs for the multicast signaling. The activation command component 1235 may be configured as or otherwise support a means for transmitting, to the first UE, the activation command activating the CSI-RS resource set. The rate-matching component 1240 may be configured as or otherwise support a means for transmitting the multicast signaling to the first UE by rate-matching, based on the activation command, around a subset of the first set of resources, where the subset is allocated for the CSI-RS.

In some examples, to support transmitting the activation command, the activation command component 1235 may be configured as or otherwise support a means for transmitting a MAC CE carried by the multicast downlink shared channel, the MAC CE including the activation command.

In some examples, the activation command includes a resource set ID assigned to the subset of the first set of resources.

In some examples, the multicast downlink shared channel is for multicast communications based on the multicast downlink shared channel being scheduled by a DCI format having an CRC scrambled by a G-RNTI or by a G-CS-RNTI, the multicast downlink shared channel being activated by a DCI format having a CRC scrambled by a G-CS-RNTI, or the multicast downlink shared channel being configured by a downlink shared channel multicast configuration or a CFR configuration.

In some examples, to support transmitting the activation command, the activation command component 1235 may be configured as or otherwise support a means for transmitting a MAC CE carried by a unicast downlink shared channel, the MAC CE including the activation command.

In some examples, the activation command includes a resource set ID that is mapped to the multicast resource set. In some examples, the activation command includes a resource set ID that is mapped to both the multicast resource set and a unicast resource set. In some examples, the activation command includes a BWP ID associated with the first set of resources.

In some examples, the unicast downlink shared channel is for unicast communications based on the unicast downlink shared channel being scheduled by a DCI format having an CRC scrambled by a C-RNTI, by a MCS-C-RNTI, or by a CS-RNTI, the unicast downlink shared channel being activated by a DCI format having a CRC scrambled by a CS-RNTI, or the unicast downlink shared channel being configured by a downlink shared channel configuration, a downlink BWP configuration, or a serving cell configuration.

In some examples, the activation delay component 1245 may be configured as or otherwise support a means for determining an activation delay for application of the activation command, the activation delay being a threshold duration after a HARQ feedback opportunity responsive to a downlink shared channel carrying the activation command.

In some examples, the activation delay component 1245 may be configured as or otherwise support a means for determining an activation delay for application of the activation command, the activation delay being a threshold duration after a minimum possible timing for a HARQ feedback opportunity responsive to a downlink shared channel carrying the activation command.

In some examples, the activation delay component 1245 may be configured as or otherwise support a means for determining an activation delay for application of the activation command, the activation delay being a threshold duration after a downlink shared channel carrying the activation command.

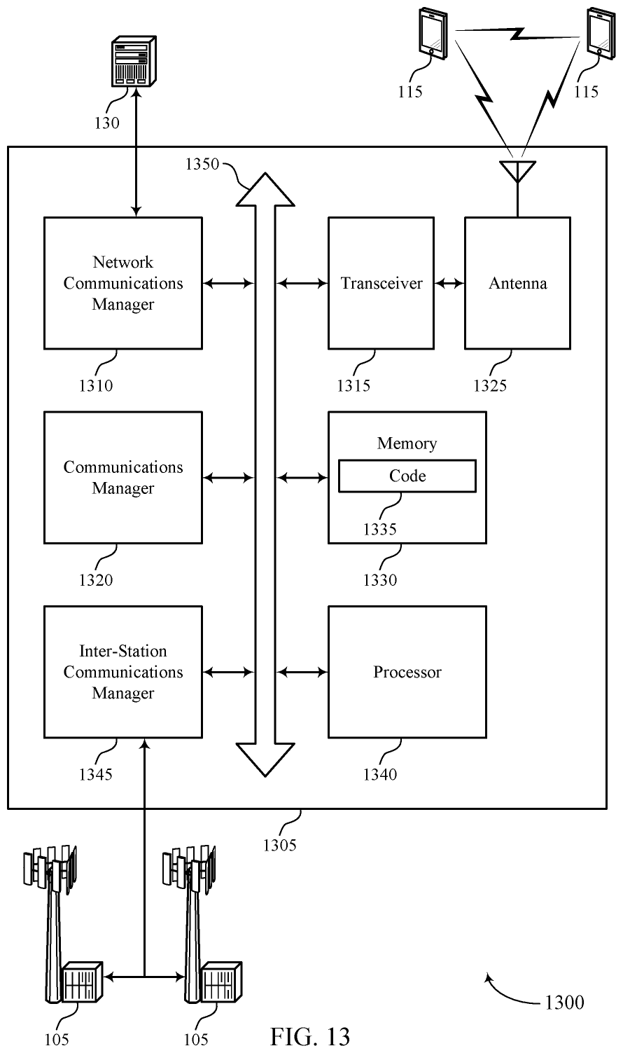

FIG. 13 shows a diagram of a system 1300 including a device 1305 that supports semi-persistent CSI-RS handling for multicast in accordance with aspects of the present disclosure. The device 1305 may be an example of or include the components of a device 1005, a device 1105, or a base station 105 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting semi-persistent CSI-RS handling for multicast). For example, the device 1305 or a component of the device 1305 may include a processor 1340 and memory 1330 coupled with or to the processor 1340, the processor 1340 and memory 1330 configured to perform various functions described herein.

The inter-station communications manager 1345 may manage communications with other base stations 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105.

The communications manager 1320 may support wireless communications at a base station in accordance with examples as disclosed herein. For example, the communications manager 1320 may be configured as or otherwise support a means for transmitting, to a first UE, a first message indicating a first configuration for a CSI-RS resource set to be activated by an activation command, where the CSI-RS resource set is for a CSI-RS, the CSI-RS including a NZP-CSI-RS or a ZP-CSI-RS. The communications manager 1320 may be configured as or otherwise support a means for transmitting, to the first UE, a second message indicating a second configuration for use by the first UE for multicast signaling via a multicast downlink shared channel over a first set of resources that are included in a first BWP allocated to the first UE for the multicast signaling and in a second BWP allocated to one or more second UEs for the multicast signaling. The communications manager 1320 may be configured as or otherwise support a means for transmitting, to the first UE, the activation command activating the CSI-RS resource set. The communications manager 1320 may be configured as or otherwise support a means for transmitting the multicast signaling to the first UE by rate-matching, based on the activation command, around a subset of the first set of resources, where the subset is allocated for the CSI-RS.

By including or configuring the communications manager 1320 in accordance with examples as described herein, the device 1305 may support techniques for improved communication reliability, reduced latency, more efficient utilization of communication resources, and improved coordination between devices.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of semi-persistent CSI-RS handling for multicast as described herein, or the processor 1340 and the memory 1330 may be otherwise configured to perform or support such operations.

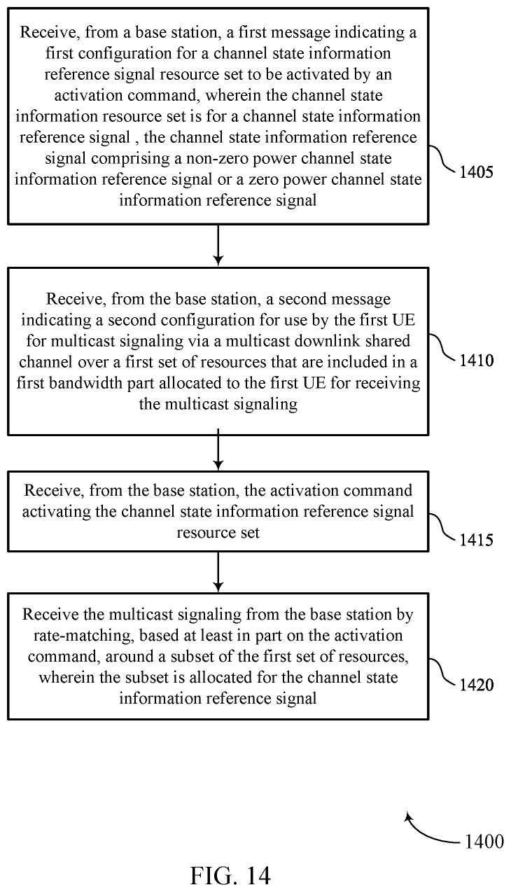

FIG. 14 shows a flowchart illustrating a method 1400 that supports semi-persistent CSI-RS handling for multicast in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1405, the method may include receiving, from a base station, a first message indicating a first configuration for a CSI-RS resource set to be activated by an activation command, where the CSI-RS resource set is for a CSI-RS, the CSI-RS including a NZP-CSI-RS or a ZP-CSI-RS. The operations of 1405 may be performed in accordance with examples as disclosed herein. In some examples, aspects of the operations of 1405 may be performed by a UE CSI-RS configuration component 825 as described with reference to FIG. 8.

At 1410, the method may include receiving, from the base station, a second message indicating a second configuration for use by the first UE for multicast signaling via a multicast downlink shared channel over a first set of resources that are included in a first BWP allocated to the first UE for receiving the multicast signaling. The operations of 1410 may be performed in accordance with examples as disclosed herein. In some examples, aspects of the operations of 1410 may be performed by a UE multicast component 830 as described with reference to FIG. 8.

At 1415, the method may include receiving, from the base station, the activation command activating the CSI-RS resource set. The operations of 1415 may be performed in accordance with examples as disclosed herein. In some examples, aspects of the operations of 1415 may be performed by a UE activation command component 835 as described with reference to FIG. 8.

At 1420, the method may include receiving the multicast signaling from the base station by rate-matching, based on the activation command, around a subset of the first set of resources, where the subset is allocated for the CSI-RS. The operations of 1420 may be performed in accordance with examples as disclosed herein. In some examples, aspects of the operations of 1420 may be performed by a UE rate-matching component 840 as described with reference to FIG. 8.

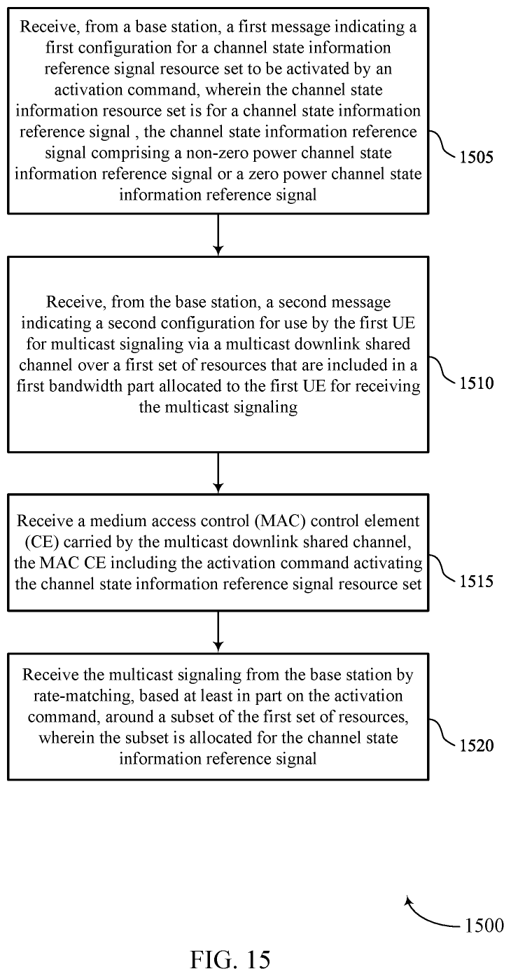

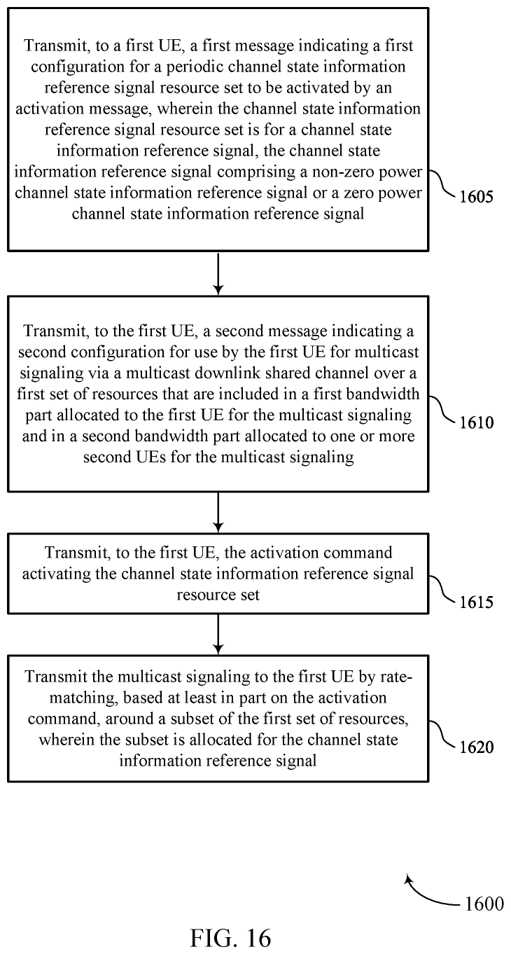

FIG. 15 shows a flowchart illustrating a method 1500 that supports semi-persistent CSI-RS handling for multicast in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1505, the method may include receiving, from a base station, a first message indicating a first configuration for a CSI-RS resource set to be activated by an activation command, where the CSI-RS resource set is for a CSI-RS, the CSI-RS including a NZP-CSI-RS or a ZP-CSI-RS. The operations of 1505 may be performed in accordance with examples as disclosed herein. In some examples, aspects of the operations of 1505 may be performed by a UE CSI-RS configuration component 825 as described with reference to FIG. 8.

At 1510, the method may include receiving, from the base station, a second message indicating a second configuration for use by the first UE for multicast signaling via a multicast downlink shared channel over a first set of resources that are included in a first BWP allocated to the first UE for receiving the multicast signaling. The operations of 1510 may be performed in accordance with examples as disclosed herein. In some examples, aspects of the operations of 1510 may be performed by a UE multicast component 830 as described with reference to FIG. 8.

At 1515, the method may include receiving a MAC CE carried by the multicast downlink shared channel, the MAC CE including the activation command activating the CSI-RS resource set. The operations of 1515 may be performed in accordance with examples as disclosed herein. In some examples, aspects of the operations of 1515 may be performed by a UE activation command component 835 as described with reference to FIG. 8.

At 1520, the method may include receiving the multicast signaling from the base station by rate-matching, based on the activation command, around a subset of the first set of resources, where the subset is allocated for the CSI-RS. The operations of 1520 may be performed in accordance with examples as disclosed herein. In some examples, aspects of the operations of 1520 may be performed by a UE rate-matching component 840 as described with reference to FIG. 8.

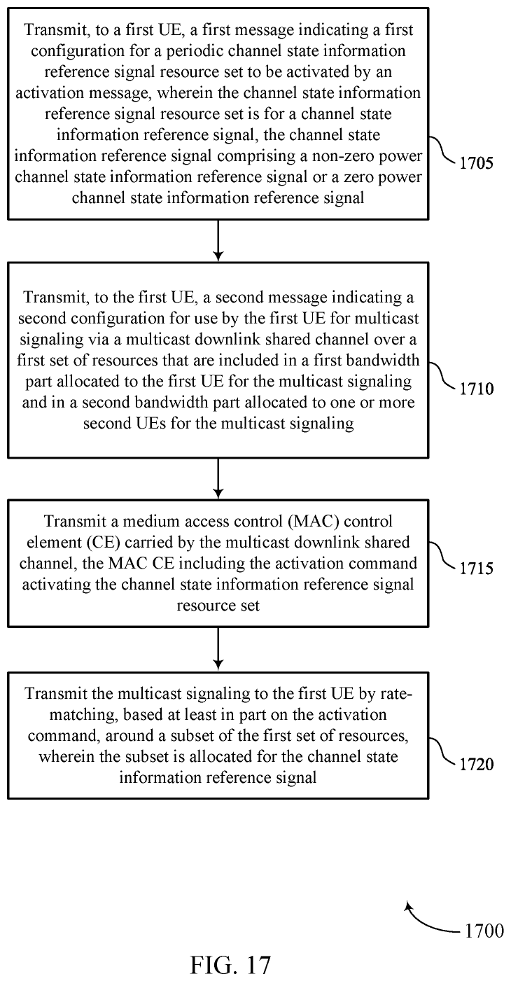

FIG. 16 shows a flowchart illustrating a method 1600 that supports semi-persistent CSI-RS handling for multicast in accordance with aspects of the present disclosure. The operations of the method 1600 may be implemented by a base station or its components as described herein. For example, the operations of the method 1600 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1605, the method may include transmitting, to a first UE, a first message indicating a first configuration for a CSI-RS resource set to be activated by an activation command, where the CSI-RS resource set is for a CSI-RS, the CSI-RS including a NZP-CSI-RS or a ZP-CSI-RS. The operations of 1605 may be performed in accordance with examples as disclosed herein. In some examples, aspects of the operations of 1605 may be performed by a CSI-RS configuration component 1225 as described with reference to FIG. 12.

At 1610, the method may include transmitting, to the first UE, a second message indicating a second configuration for use by the first UE for multicast signaling via a multicast downlink shared channel over a first set of resources that are included in a first BWP allocated to the first UE for the multicast signaling and in a second BWP allocated to one or more second UEs for the multicast signaling. The operations of 1610 may be performed in accordance with examples as disclosed herein. In some examples, aspects of the operations of 1610 may be performed by a multicast component 1230 as described with reference to FIG. 12.

At 1615, the method may include transmitting, to the first UE, the activation command activating the CSI-RS resource set. The operations of 1615 may be performed in accordance with examples as disclosed herein. In some examples, aspects of the operations of 1615 may be performed by an activation command component 1235 as described with reference to FIG. 12.

At 1620, the method may include transmitting the multicast signaling to the first UE by rate-matching, based on the activation command, around a subset of the first set of resources, where the subset is allocated for the CSI-RS. The operations of 1620 may be performed in accordance with examples as disclosed herein. In some examples, aspects of the operations of 1620 may be performed by a rate-matching component 1240 as described with reference to FIG. 12.

FIG. 17 shows a flowchart illustrating a method 1700 that supports semi-persistent CSI-RS handling for multicast in accordance with aspects of the present disclosure. The operations of the method 1700 may be implemented by a base station or its components as described herein. For example, the operations of the method 1700 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1705, the method may include transmitting, to a first UE, a first message indicating a first configuration for a CSI-RS resource set to be activated by an activation command, where the CSI-RS resource set is for a CSI-RS, the CSI-RS including a NZP-CSI-RS or a ZP-CSI-RS. The operations of 1705 may be performed in accordance with examples as disclosed herein. In some examples, aspects of the operations of 1705 may be performed by a CSI-RS configuration component 1225 as described with reference to FIG. 12.

At 1710, the method may include transmitting, to the first UE, a second message indicating a second configuration for use by the first UE for multicast signaling via a multicast downlink shared channel over a first set of resources that are included in a first BWP allocated to the first UE for the multicast signaling and in a second BWP allocated to one or more second UEs for the multicast signaling. The operations of 1710 may be performed in accordance with examples as disclosed herein. In some examples, aspects of the operations of 1710 may be performed by a multicast component 1230 as described with reference to FIG. 12.

At 1715, the method may include transmitting a MAC CE carried by the multicast downlink shared channel, the MAC CE including the activation command activating the CSI-RS resource set. The operations of 1715 may be performed in accordance with examples as disclosed herein. In some examples, aspects of the operations of 1715 may be performed by an activation command component 1235 as described with reference to FIG. 12.

At 1720, the method may include transmitting the multicast signaling to the first UE by rate-matching, based on the activation command, around a subset of the first set of resources, where the subset is allocated for the CSI-RS. The operations of 1720 may be performed in accordance with examples as disclosed herein. In some examples, aspects of the operations of 1720 may be performed by a rate-matching component 1240 as described with reference to FIG. 12.

The following provides an overview of aspects of the present disclosure:

Aspect 1: A method for wireless communications at a first UE, comprising: receiving, from a base station, a first message indicating a first configuration for a CSI-RS resource set to be activated by an activation command, wherein the CSI-RS resource set is for a CSI-RS, the CSI-RS comprising a NZP-CSI-RS or a ZP-CSI-RS; receiving, from the base station, a second message indicating a second configuration for use by the first UE for multicast signaling via a multicast downlink shared channel over a first set of resources that are included in a first BWP allocated to the first UE for receiving the multicast signaling; receiving, from the base station, the activation command activating the CSI-RS resource set; and receiving the multicast signaling from the base station by rate-matching, based at least in part on the activation command, around a subset of the first set of resources, wherein the subset is allocated for the CSI-RS.

Aspect 2: The method of aspect 1, wherein receiving the activation command further comprises: receiving a MAC CE carried by the multicast downlink shared channel, the MAC CE including the activation command.

Aspect 3: The method of aspect 2, further comprising: identifying the subset of the first set of resources as a multicast resource set for the CSI-RS based at least in part on a resource set ID included within the activation command and the MAC CE being carried by the multicast downlink shared channel.

Aspect 4: The method of any of aspects 2 and 3, further comprising: refraining from rate-matching around a unicast resource set for the CSI-RS based at least in part on the MAC CE being carried by the multicast downlink shared channel.

Aspect 5: The method of any of aspects 2 through 4, wherein the multicast downlink shared channel is for multicast communications based at least in part on the multicast downlink shared channel being scheduled by a DCI format having an CRC scrambled by a G-RNTI or by a G-CS-RNTI, the multicast downlink shared channel being activated by a DCI format having a CRC scrambled by a G-CS-RNTI, or the multicast downlink shared channel being configured by a downlink shared channel multicast configuration or a common frequency resource configuration.

Aspect 6: The method of aspect 1, wherein receiving the activation command further comprises: receiving a MAC CE carried by a unicast downlink shared channel, the MAC CE including the activation command.

Aspect 7: The method of aspect 6, further comprising: identifying the subset of the first set of resources as a multicast resource set for the CSI-RS based at least in part on a resource set ID included within the activation command, the resource set ID uniquely mapped to the multicast resource set.

Aspect 8: The method of aspect 7, further comprising: refraining from rate-matching around a unicast resource set for the CSI-RS based at least in part on the resource set ID being uniquely mapped to the multicast resource set.

Aspect 9: The method of aspect 6, further comprising: identifying the subset of the first set of resources as a multicast resource set for the CSI-RS and a second subset of a second set of resources as a unicast resource set for the CSI-RS, the identifying of both the subset and the second subset based at least in part on a resource set ID included within the activation command, the resource set ID mapped to both the multicast resource set and the unicast resource set.

Aspect 10: The method of any of the aspects of 6 through 9, further comprising: identifying the subset of the first set of resources as a multicast resource set for the CSI-RS based at least in part on a BWP ID included within the activation command, the BWP ID being associated with the first set of resources.

Aspect 11: The method of aspect 10, wherein identifying the subset of the first set of resources further comprises: identifying the subset of the first set of resources based at least in part on a resource set ID included within the activation command.

Aspect 12: The method of any of aspects 6 through 11, wherein the unicast downlink shared channel is for unicast communications based at least in part on the unicast downlink shared channel being scheduled by a DCI format having an CRC scrambled by a C-RNTI, by a MCS-C-RNTI, or by a CS-RNTI, the unicast downlink shared channel being activated by a DCI format having a CRC scrambled by a CS-RNTI, or the unicast downlink shared channel being configured by a downlink shared channel configuration, a downlink BWP configuration, or a serving cell configuration.

Aspect 13: The method of any of aspects 1 through 12, further comprising: determining an activation delay for application of the activation command, the activation delay being a threshold duration after a HARQ feedback opportunity responsive to a downlink shared channel carrying the activation command.

Aspect 14: The method of any of aspects 1 through 12, further comprising: determining an activation delay for application of the activation command, the activation delay being a threshold duration after a minimum possible timing for a HARQ feedback opportunity responsive to a downlink shared channel carrying the activation command.

Aspect 15: The method of any of aspects 1 through 12, further comprising: determining an activation delay for application of the activation command, the activation delay being a threshold duration after a downlink shared channel carrying the activation command.

Aspect 16: A method for wireless communications at a base station, comprising: transmitting, to a first UE, a first message indicating a first configuration for a CSI-RS resource set to be activated by an activation command, wherein the CSI-RS resource set is for a CSI-RS, the CSI-RS comprising a NZP-CSI-RS or a ZP-CSI-RS; transmitting, to the first UE, a second message indicating a second configuration for use by the first UE for multicast signaling via a multicast downlink shared channel over a first set of resources that are included in a first BWP allocated to the first UE for the multicast signaling and in a second BWP allocated to one or more second UEs for the multicast signaling; transmitting, to the first UE, the activation command activating the CSI-RS resource set; and transmitting the multicast signaling to the first UE by rate-matching, based at least in part on the activation command, around a subset of the first set of resources, wherein the subset is allocated for the CSI-RS.

Aspect 17: The method of aspect 16, wherein transmitting the activation command further comprises: transmitting a MAC CE carried by the multicast downlink shared channel, the MAC CE including the activation command.

Aspect 18: The method of aspect 17, wherein the activation command comprises a resource set ID assigned to the subset of the first set of resources.

Aspect 19: The method of any of aspects 17 and 18, wherein the multicast downlink shared channel is for multicast communications based at least in part on the multicast downlink shared channel being scheduled by a DCI format having an CRC scrambled by a G-RNTI or by a G-CS-RNTI, the multicast downlink shared channel being activated by a DCI format having a CRC scrambled by a G-CS-RNTI, or the multicast downlink shared channel being configured by a downlink shared channel multicast configuration or a common frequency resource configuration.

Aspect 20: The method of aspect 16, wherein transmitting the activation command further comprises: transmitting a MAC CE carried by a unicast downlink shared channel, the MAC CE including the activation command.

Aspect 21: The method of aspect 20, wherein the activation command comprises a resource set ID that is uniquely mapped to the multicast resource set.

Aspect 22: The method of aspect 20, wherein the activation command comprises a resource set ID that is mapped to both the multicast resource set and a unicast resource set.

Aspect 23: The method of any of aspects 20 through 22, wherein the activation command comprises a BWP ID associated with the first set of resources.

Aspect 24: The method of any of aspects 20 through 23, wherein the unicast downlink shared channel is for unicast communications based at least in part on the unicast downlink shared channel being scheduled by a DCI format having an CRC scrambled by a C-RNTI, by a MCS-C-RNTI, or by a CS-RNTI, the unicast downlink shared channel being activated by a DCI format having a CRC scrambled by a CS-RNTI, or the unicast downlink shared channel being configured by a downlink shared channel configuration, a downlink BWP configuration, or a serving cell configuration.

Aspect 25: The method of any of aspects 16 through 24, further comprising: determining an activation delay for application of the activation command, the activation delay being a threshold duration after a HARQ feedback opportunity responsive to a downlink shared channel carrying the activation command.

Aspect 26: The method of any of aspects 16 through 24, further comprising: determining an activation delay for application of the activation command, the activation delay being a threshold duration after a minimum possible timing for a HARQ feedback opportunity responsive to a downlink shared channel carrying the activation command.

Aspect 27: The method of any of aspects 16 through 24, further comprising: determining an activation delay for application of the activation command, the activation delay being a threshold duration after a downlink shared channel carrying the activation command.

Aspect 28: An apparatus for wireless communications, comprising a processor; memory coupled with the processor; and instructions stored in the memory and executable by the processor to cause the apparatus to perform a method of any of aspects 1 through 15.

Aspect 29: An apparatus for wireless communications, comprising at least one means for performing a method of any of aspects 1 through 15.

Aspect 30: A non-transitory computer-readable medium storing code for wireless communications at a first UE, the code comprising instructions executable by a processor to perform a method of any of aspects 1 through 15.

Aspect 31: An apparatus for wireless communications, comprising a processor; memory coupled with the processor; and instructions stored in the memory and executable by the processor to cause the apparatus to perform a method of any of aspects 16 through 27.

Aspect 32: An apparatus for wireless communications, comprising at least one means for performing a method of any of aspects 16 through 27.

Aspect 33: A non-transitory computer-readable medium storing code for wireless communications at a base station, the code comprising instructions executable by a processor to perform a method of any of aspects 16 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications, comprising:
a processor;
memory coupled with the processor; and
instructions stored in the memory and executable by the processor to cause the apparatus to:
receive, from a network device, a first message indicating a first configuration for a channel state information reference signal resource set to be activated by an activation command, wherein the channel state information reference signal resource set is for a channel state information reference signal, the channel state information reference signal comprising a non-zero power channel state information reference signal or a zero power channel state information reference signal;
receive, from the network device, a second message indicating a second configuration for use by a first user equipment (UE) for multicast signaling via a multicast downlink shared channel over a first set of resources that are included in a first bandwidth part allocated to the first UE for receiving the multicast signaling;
receive, from the network device, the activation command activating the channel state information reference signal resource set; and
receive the multicast signaling from the network device by rate-matching, based at least in part on the activation command, around a subset of the first set of resources, wherein the subset is allocated for the channel state information reference signal.

2. The apparatus of claim 1, wherein the instructions are further executable to cause the apparatus to:
determine an activation delay for application of the activation command, the activation delay being a threshold duration after a hybrid automatic repeat request feedback opportunity responsive to a downlink shared channel carrying the activation command.

3. The apparatus of claim 1, wherein the instructions to receive the activation command are further executable by the processor to cause the apparatus to:
receive a medium access control (MAC) control element (CE) carried by a unicast downlink shared channel, the MAC CE including the activation command.

4. The apparatus of claim 3, wherein the instructions are further executable by the processor to cause the apparatus to:
identify the subset of the first set of resources as a multicast resource set for the channel state information reference signal based at least in part on a resource set index included within the activation command.

5. The apparatus of claim 3, wherein the instructions are further executable by the processor to cause the apparatus to:
receive a second activation command activating a second channel state information reference signal resource set, the second activation command received via a second medium access control (MAC) control element (CE) by the unicast downlink shared channel;
identify a subset of a second set of resources as a unicast resource set for a second channel state information reference signal based at least in part on a resource set index included within the second activation command; and
receive unicast signaling from the network device by rate-matching, based at least in part on the second activation command, around the subset of the second set of resources, wherein the subset is allocated for the second channel state information reference signal.

6. The apparatus of claim 3, wherein the instructions are further executable by the processor to cause the apparatus to:
identify the subset of the first set of resources as a multicast resource set for the channel state information reference signal and a second subset of a second set of resources as a unicast resource set for the channel state information reference signal, the identifying of both the subset and the second subset based at least in part on a resource set index included within the activation command, the resource set index mapped to both the multicast resource set and the unicast resource set.

7. The apparatus of claim 3, wherein the instructions are further executable by the processor to cause the apparatus to:
identify the subset of the first set of resources as a multicast resource set for the channel state information reference signal based at least in part on a bandwidth part index included within the activation command, the bandwidth part index being associated with the first set of resources.

8. The apparatus of claim 7, wherein the instructions to identify the subset of the first set of resources are further executable by the processor to cause the apparatus to:
identify the subset of the first set of resources based at least in part on a resource set index included within the activation command.

9. The apparatus of claim 3, wherein the unicast downlink shared channel is for unicast communications based at least in part on the unicast downlink shared channel being scheduled by a downlink control information (DCI) format having a cyclic redundancy check (CRC) scrambled by a cell random network temporary identifier (C-RNTI), by a modulation and coding scheme cell random network temporary identifier (MCS-C-RNTI), or by a configured scheduling random network temporary identifier (CS-RNTI), the unicast downlink shared channel being activated by a DCI format having a CRC scrambled by a CS-RNTI, or the unicast downlink shared channel being configured by a downlink shared channel configuration, a downlink bandwidth part configuration, or a serving cell configuration.

10. The apparatus of claim 1, wherein the instructions to receive the activation command are further executable by the processor to cause the apparatus to:
receive a medium access control (MAC) control element (CE) carried by the multicast downlink shared channel, the MAC CE including the activation command.

11. The apparatus of claim 10, wherein the instructions are further executable by the processor to cause the apparatus to:
identify the subset of the first set of resources as a multicast resource set for the channel state information reference signal based at least in part on a resource set index included within the activation command and the MAC CE being carried by the multicast downlink shared channel.

12. The apparatus of claim 10, wherein the instructions are further executable by the processor to cause the apparatus to:
refrain from rate-matching around a unicast resource set for the channel state information reference signal based at least in part on the MAC CE being carried by the multicast downlink shared channel.

13. The apparatus of claim 10, wherein the multicast downlink shared channel is for multicast communications based at least in part on the multicast downlink shared channel being scheduled by a downlink control information (DCI) format having a cyclic redundancy check (CRC) scrambled by a group random network temporary identifier (G-RNTI) or by a group configured scheduling random network temporary identifier (G-CS-RNTI), the multicast downlink shared channel being activated by a DCI format having a CRC scrambled by a G-CS-RNTI, or the multicast downlink shared channel being configured by a downlink shared channel multicast configuration or a common frequency resource configuration.

14. The apparatus of claim 1, wherein the instructions are further executable by the processor to cause the apparatus to:
determine an activation delay for application of the activation command, the activation delay being a threshold duration after a minimum possible timing for a hybrid automatic repeat request feedback opportunity responsive to a downlink shared channel carrying the activation command.

15. The apparatus of claim 1, wherein the instructions are further executable by the processor to cause the apparatus to:
determine an activation delay for application of the activation command, the activation delay being a threshold duration after a downlink shared channel carrying the activation command.

16. An apparatus for wireless communications, comprising:
a processor;
memory coupled with the processor; and
instructions stored in the memory and executable by the processor to cause the apparatus to:
transmit a first message indicating a first configuration for a channel state information reference signal resource set to be activated by an activation command, wherein the channel state information reference signal resource set is for a channel state information reference signal, the channel state information reference signal comprising a non-zero power channel state information reference signal or a zero power channel state information reference signal;
transmit a second message indicating a second configuration for use by a first user equipment (UE) for multicast signaling via a multicast downlink shared channel over a first set of resources that are included in a first bandwidth part allocated to the first UE for the multicast signaling and in a second bandwidth part allocated to one or more second UEs for the multicast signaling;
transmit the activation command activating the channel state information reference signal resource set; and
transmit the multicast signaling by rate-matching, based at least in part on the activation command, around a subset of the first set of resources, wherein the subset is allocated for the channel state information reference signal.

17. The apparatus of claim 16, wherein the instructions are further executable by the processor to cause the apparatus to:
determine an activation delay for application of the activation command, the activation delay being a threshold duration after a hybrid automatic repeat request feedback opportunity responsive to a downlink shared channel carrying the activation command.

18. The apparatus of claim 16, wherein the instructions to transmit the activation command are further executable by the processor to cause the apparatus to:
transmit a medium access control (MAC) control element (CE) carried by a unicast downlink shared channel, the MAC CE including the activation command.

19. The apparatus of claim 18, wherein the activation command comprises a resource set index that is mapped to the multicast resource set.

20. The apparatus of claim 18, wherein the activation command comprises a resource set index that is mapped to both the multicast resource set and a unicast resource set.

21. The apparatus of claim 18, wherein the activation command comprises a bandwidth part index associated with the first set of resources.

22. The apparatus of claim 18, wherein the unicast downlink shared channel is for unicast communications based at least in part on the unicast downlink shared channel being scheduled by a downlink control information (DCI) format having a cyclic redundancy check (CRC) scrambled by a cell random network temporary identifier (C-RNTI), by a modulation and coding scheme cell random network temporary identifier (MCS-C-RNTI), or by a configured scheduling random network temporary identifier (CS-RNTI), the unicast downlink shared channel being activated by a DCI format having a CRC scrambled by a CS-RNTI, or the unicast downlink shared channel being configured by a downlink shared channel configuration, a downlink bandwidth part configuration, or a serving cell configuration.

23. The apparatus of claim 16, wherein the instructions to transmit the activation command are further executable by the processor to cause the apparatus to:
transmit a medium access control (MAC) control element (CE) carried by the multicast downlink shared channel, the MAC CE including the activation command.

24. The apparatus of claim 23, wherein the activation command comprises a resource set index assigned to the subset of the first set of resources.

25. The apparatus of claim 23, wherein the multicast downlink shared channel is for multicast communications based at least in part on the multicast downlink shared channel being scheduled by a downlink control information (DCI) format having a cyclic redundancy check (CRC) scrambled by a group random network temporary identifier (G-RNTI) or by a group configured scheduling random network temporary identifier (G-CS-RNTI), the multicast downlink shared channel being activated by a DCI format having a CRC scrambled by a G-CS-RNTI, or the multicast downlink shared channel being configured by a downlink shared channel multicast configuration or a common frequency resource configuration.

26. The apparatus of claim 16, wherein the instructions are further executable by the processor to cause the apparatus to:
determine an activation delay for application of the activation command, the activation delay being a threshold duration after a minimum possible timing for a hybrid automatic repeat request feedback opportunity responsive to a downlink shared channel carrying the activation command.

27. A method for wireless communications at a first user equipment (UE), comprising:
receiving, from a network device, a first message indicating a first configuration for a channel state information reference signal resource set to be activated by an activation command, wherein the channel state information reference signal resource set is for a channel state information reference signal, the channel state information reference signal comprising a non-zero power channel state information reference signal or a zero power channel state information reference signal;
receiving, from the network device, a second message indicating a second configuration for use by a first UE for multicast signaling via a multicast downlink shared channel over a first set of resources that are included in a first bandwidth part allocated to the first UE for receiving the multicast signaling;
receiving, from the network device, the activation command activating the channel state information reference signal resource set; and
receiving the multicast signaling from the network device by rate-matching, based at least in part on the activation command, around a subset of the first set of resources, wherein the subset is allocated for the channel state information reference signal.

28. The method of claim 27, wherein receiving the activation command comprises:
receiving a medium access control (MAC) control element (CE) carried by a unicast downlink shared channel, the MAC CE including the activation command.

29. A method for wireless communications at a network device, comprising:
transmitting a first message indicating a first configuration for a channel state information reference signal resource set to be activated by an activation command, wherein the channel state information reference signal resource set is for a channel state information reference signal, the channel state information reference signal comprising a non-zero power channel state information reference signal or a zero power channel state information reference signal;
transmitting a second message indicating a second configuration for use by a first user equipment (UE) for multicast signaling via a multicast downlink shared channel over a first set of resources that are included in a first bandwidth part allocated to the first UE for the multicast signaling and in a second bandwidth part allocated to one or more second UEs for the multicast signaling;
transmitting the activation command activating the channel state information reference signal resource set; and
transmitting the multicast signaling by rate-matching, based at least in part on the activation command, around a subset of the first set of resources, wherein the subset is allocated for the channel state information reference signal.

30. The method of claim 29, wherein transmitting the activation command comprises:
transmitting a medium access control (MAC) control element (CE) carried by a unicast downlink shared channel, the MAC CE including the activation command.
